(19) United States
(12) Patent Application Publication
(10) Pub. No.: US 2023/0272739 A1
(43) Pub. Date: Aug. 31, 2023

(54) ORBITAL-EPICYCLE CRANKSHAFT WITH A REVERSIBLE AND ADJUSTABLE CONSTANT VOLUME COMBUSTION CYCLE AT TDC OR BDC

(71) Applicant: Borislav Zivkovich, Hammond, IN (US)

(72) Inventor: Borislav Zivkovich, Hammond, IN (US)

(21) Appl. No.: 17/681,712

(22) Filed: Feb. 26, 2022

(51) Int. Cl. F02B 75/04; F02B 75/02; F01L 31/12

(52) U.S. Cl. CPC F02B 75/048; F02B 75/02; F01L 31/12; F02B 2075/025; F02B 2075/027

(57) ABSTRACT

An improved internal combustion engine utilizes at least one orbital-epicycle crankpin eccentrically offset from an orbital shaft, rotationally linked to the main shaft via an orbital-epicyclic gear set, such that the piston and connecting rod, influenced by the force from the thermodynamic process, transfers a straight linear force to the orbital-epicyclic crankpin via a conventional connecting rod and the two-piece flying crank arm to the main shaft. The concept provides a simple way of adjusting or inverting the piston to crank relationship for a different engine application and fuel characteristics with a variety of (dwell duration) ECVC cycle durations to appear at TDC or BDC. Consider that; volume vs pressure/heat are in an opposed proportion!

### TECHNICAL FIELD

The present disclosure is related generally to internal combustion engines and, more particularly to a system and method for providing a substantially constant but adjustable volume period within the combustion cycle and/or adjustable/extended dwell time of a physical reciprocating motion of a mechanical element.

### BACKGROUND

Under an onslaught of regulatory and economic demands, reciprocating internal combustion engines (ICEs) have come very close to peak efficiency and NOX emission reduction. However, such engines, both spark-ignited and compression-ignited, are facing new challenges concerning mileage and efficiency due to the price of petroleum and petroleum distillates.

Existing spark and compression-ignited ICEs utilize a crankshaft with a connecting crankpin that remains at a constant distance from the center of the main crankshaft journal. This structure, based on the wheel and eccentric pin, has been used essentially unchanged since the 14^{th} century to produce very simple reciprocating mechanical movements, i.e., to break stones, calendar cereals, and for hammering and shaping metals.

The eccentric pin with a constant distance to the center of rotation was inherited and implemented in external heat Alfa Sterling steam engines, which were conceived and patented by Jean-Joseph Etienne Lenoir in 1860. A short time later in 1867 Paris, Nicholas August Otto constructed and demonstrated the first internal combustion engine. Continuing this progress, Herbert Stuart invented the first fuel pressure-injected internal combustion engine in 1891, and in 1892 Rudolf Diesel patented essentially the same structure with the four-cycle operation.

For the turn of the century industry and society, the eccentric pin with a constant distance to the center of rotation in an external engine was a useful concept due to the external preparation of the pressure. For example, a steam engine does not benefit from any amount of piston dwell time at TDC (top dead center) and new piston to crankshaft relationship. Indeed, extended dwell time would cause the steam charge to lose a small amount of heat or energy, reducing efficiency.

However, for use in ICEs, the eccentric pin with a constant distance to the center of rotation has numerous disadvantages, especially with respect to the piston's movement around the top dead center. This mechanical arrangement sets an inadequate but mechanically permanent piston to crank relationship. In the first 90° of moving from BDC (bottom dead center) toward TDC, the piston is moving relatively slowly, meaning that the temperature of the charge is also only increasing slowly. In the second 90° of crank rotation from BDC, the piston has a longer, faster linear response, which means it travels faster and raises the charge temperature faster. This sequence sets very strict parameters, requiring sophisticated combustion management processes and techniques. Thus only very controlled octane-hexagon proportions of the fuel will sustain the changes of the values distributed exponentially to a given time constant. This inadequate piston to crank relationship with the piston moving too fast at the end of its physical reciprocating motion directly causes a secondary imbalance of the forces.

Moreover, the existing eccentric pin at a constant distance provides only a brief moment at and around TDC with no volume changes. Indeed, without allowing for slight looseness intolerances, there is essentially no constant volume regime anywhere along with the piston's travel. Allowing for tolerances, and using a loose definition of “constant,” perhaps one could say that from −4° to +4° ( 1/45 of 360°) the piston doesn't change the volume of the combustion chamber appreciably. At 720 RPM, this period would last 0.0018 sec. Increasing RPM from idle speed to max. For instance, to 7200 RPM, the pseudo-constant volume regime duration at TDC will be further cut to a tenth of that.

The lack of time at TDC and inadequate volumetric increase while performing power stroke versus crank time has been generally known, and solutions have been attempted by using a variety of systems to compensate for these deficiencies. Various systems such as variable ignition with common rail direct fuel injection system, variable intake runners, and sophisticated combustion management systems have been used to guide and supervise the combustion process before and after TDC. In the conventional mechanical concept, using today's fuel, the combustion process must start substantially before TDC, creating a huge resistance by raising the heat chemically in parallel with physical compression. The ignition of the charge is happening while the flat-plane crankshaft is in its power gap; especially with higher RPMs, the concept relies on using accumulated flywheel torque to complete the last stage of the compression stroke.

The crankpin with a constant distance to the center of rotation has then partially developed thermodynamic processes and only partially converted thermal energy to useful mechanical work throughout power stroke. When spark ignited, the mechanical concept has a maximum thermal efficiency of about 30%, with the rest of the energy being lost in the form of unfinished combustion gasses which are then exposed to multiple techniques and after-treatment accessories to remediate the incomplete combustion process. Some of these after processes are known, e.g., recompression, where the exhaust valve remains closed while the piston starts moving from the BDC up extending the burning process further into the exhaust cycle, pipe flow of the gasses is further exposed to rotate the turbocharger turbine where is constantly maintaining higher pressure and heat to stimulate further atomization.

At the end of this very important method by the conventional concept and closer to the end piston motion, the system enters the EGR system returning a portion of unburned gasses to the next intake cycle. The unburned gasses past this point are further exposed to other after-treatment accessories like two or three-way catalytic converters. Compression ignited concepts use an excess volume of fuel, relying on using the techniques mentioned above and additional EGR, PDF, DEF to remediate the failure of the mechanical concept. This all proves that the conventional crankshaft design limits the thermodynamic process to a certain level of efficiency.

Thanks to the development of many conventional improvements such as VVT and VVL, engine combustion management systems can pick and choose the profile of the combustion process, the size of the charge coordinated with your request and driving conditions, as well as direct fuel injection system, has allowed the conventional ICE concept with its inadequate piston to crank relationship to withstand competition. From the beginning of its development until today, many attempts have been made to change the conventional crank system, piston to crank relationship. However, all such attempts resulted in an even faster volumetric increase with a piston after TDC, while the conventional crank already lacks sufficient time at that stage of the stroke for a fuller atomization process.

While the present disclosure is directed to a system that can eliminate certain shortcomings noted in or apparent from this Background section, it should be appreciated that such a benefit is neither a limitation on the scope of the disclosed principles nor of the attached claims, except to the extent expressly noted in the claims. Additionally, the discussion of technology in this Background section is reflective of the inventors' observations, considerations, and thoughts, and is in no way intended to accurately catalog or comprehensively summarize the art currently in the public domain. As such, the inventors expressly disclaim this section as admitted or assumed prior art. Moreover, the identification herein of a desirable course of action reflects the inventors' observations and ideas, and should not be assumed to indicate art-recognized desirability.

### SUMMARY

In keeping with an embodiment of the disclosed principles, an improved internal combustion engine utilizes at least one orbital crank journal rotationally linked to the main crank journal, diametrically offset from the center of the orbital body-axis 22a with C2 in a specific way as further described in paragraphs below. The orbital crank journal together with the orbital body and planetary gear is geared to the sun gear fixed to the block via a 1:1 gearing ratio, with an identical pitch circle radius. In this way, the orbiting pin is influenced by the expansion of the gasses inside the cylinder via connecting rod turning the orbital crank journal around its center and the orbiting center and using the epicyclic motion of the two gears to create the Variable Rod to Stroke Ratio mechanical concept. This orbital-epicycle motion creates an irregular but vertically symmetrical circular path of the center of orbiting pin (journal), thus resulting in an extended constant volume period up to 60° crank time engaging the piston with the crank in a new and advanced mechanical relationship. Simply engaging the piston with the right spin at the right crank angular position, improves the operation, thermal efficiency, and cleanliness of the engine. Other features and aspects of embodiments of the disclosed principals will be appreciated from the detailed disclosure taken in conjunction with the included figures.

### BRIEF DESCRIPTION OF THE SEVERAL VIEWS OF THE DRAWING

While the appended claims set forth the features of the present techniques with particularity, these techniques, together with their objects and advantages, may be best understood from the following detailed description taken in conjunction with the accompanying drawings of which.

FIG. 1 is a schematic illustration showing a practical example of how to use the invention if the ECVC cycle and slow motion of the piston are desired to be before and after the TDC with a stroke of 4,250″. The following Variable Rod-Stroke Ratio mechanical concept is a unique mechanical concept and is presented here to: modify the conventional cycle's time duration, dwell time, piston to crank relationship, and shortness of the crank lever while in the second half of the cycle (power stroke).

FIG. 2 is also a schematic illustration showing the following Variable Rod—Stroke Ratio mechanical engagement and of the two epicyclic gears.

FIG. 3 illustrates the creation of an irregular circular path using mechanical elements engaged in a new fashion to achieve the modification of conventional cycles. The figure uses simplified presentation and contents as follow; orbital pin (journal) C1, orbital body axis with center labeled as C2, main journal axis rotatable affixed in the block with center C3, planetary gear helical tooth style 5 with the same center C2 as orbital body axis, stationary collar gear with helical tooth style one-piece construction 6, pitch circles 5a and 5b, pitch radius of the planetary gear pr1, pitch radius of stationary gear labeled as pr2.

FIG. 4 is a detailed view of ½ of the system shown in FIG. 1, with the planetary shaft and center C1 engaged in an orbital-epicycle motion around the center of revolving and orbiting center C2 to create Extended Constant Volume Combustion Cycle ECVC or (EDDUR) at TDC or BDC.

FIG. 5 is an exploded perspective view of one crank throw of an orbital-epicycle crankshaft embodying VR/SR mechanical principles of engine operation. Further shown are disassembled elements per an embodiment of the disclosed principles of a single orbital-epicycle crankpin which demonstrates a simple ability to reconfigure engine kinematics. Turning the orbital gear 5 shaft around its center for 180° before meshing with stationary to the block sun collar gear 6 will set the ECVC cycle or extended dwell duration (EDDUR) and slower piston response to crank rotation at TDC point. The specific crankshaft draft is further seen and implemented in an opposed piston-opposed cylinder concept with partial sequential animation and 2D view in later figures.

FIG. 6 is a 2D view of a flat plane VR/CR crankshaft with single crank pins per each crank throw for a horizontal two piston engine or an OPOC engine with two common cylinders and four pistons per an embodiment of the disclosed principles. Contents of the figure are orbital journal center C1, revolving and orbital center C2, the main center of rotation C3, opposed crank journal on the same orbital shaft C4 opposed crank throw orbital journals C5, C6, with optional two-piece construction of collar helical sun gear 6a and 6b, horizontally opposed crank throw 8, orbital cap 22, flywheel flange 23, and two-part thrust motion termination ring 24.

FIG. 7 presents a PV diagram of compression and expansion cycles with comparable data plots showing the cylinder pressure curves for a traditional engine 110 and an engine with an embodiment of the disclosed principles 111. The projected VR/SR network is based on the new piston to crank relationship, where the reduction of the volumetric displacement has a direct impact on MEP and cylinder pressure. The system provides additional dwell time after TDC allowing variable ignition to accrue from 5°-15° after the TDC point. Delaying the ignition and beginning of fuel propagation for better crank pin position reduces the lateral stress onto components, eliminates flow buy gasses at and around TDC and bypasses normally excessive resistance of the expansion of ignited gasses before TDC. Accordingly, this reduces the dependence on flywheel torque to complete the second half of the compression cycle, where the engine with conventional flat-plane crankshaft is left with a power gap.

The orbital-epicycle crankshaft together with orbital-epicycle crank pin revolves around the center C2 to 30° after TDC and holds the charge in a volumetrically entrapped position without interrupting the angular momentum of the entire system. Throughout this crank rotation orbital center C1 maintains a lower crank arm equal to 22° of the conventional crankshaft. A dynamic compression stroke and slower volumetric increase from 30°-75° after TDC gives an effect of an increased compression ratio, creates an environment for better fuel propagation and fuller atomization, resulting in improvement of the dual cycle 114. Considering that volume vs pressure/heat is in an opposed proportion.

FIG. 8 is a schematic operating diagram of the VR/SR mechanical concept compared with the conventional model, both using square bore to stroke ratio and the same Rod to Stroke Ratio of 1.75:1. Both comparable models are at the BDC point.

FIG. 9 is another sequential schematic operating diagram of the VR/SR mechanical concept compared with the conventional model, both using square bore to stroke ratio and the same Rod to Stroke Ratio of 1.75:1. Both models are at 90° before the TDC point.

FIG. 10 is another sequential schematic operating diagram of the VR/SR mechanical concept compared with the conventional model, both using square bore to stroke ratio and the same Rod to Stroke Ratio of 1.75:1. Both models are at 60° before the TDC point.

FIG. 11 is another sequential schematic operating diagram of the VR/SR mechanical concept compared with the conventional model, both using square bore to stroke ratio and the same Rod to Stroke Ratio of 1.75:1. Both models are at 30° before the TDC point.

FIG. 12 is another sequential schematic operating diagram of the VR/SR mechanical concept compared with the conventional model, both using square bore to stroke ratio and the same Rod to Stroke Ratio of 1.75:1. Both models are at the Conventional TDC point.

FIG. 13 is another sequential schematic operating diagram of the VR/SR mechanical concept compared with the conventional model, both using square bore to stroke ratio and the same Rod to Stroke Ratio of 1.75:1. Both models are at 30° after the TDC point.

FIG. 14 is another sequential schematic operating diagram of the VR/SR mechanical concept compared with the conventional model, both using square bore to stroke ratio and the same Rod to Stroke Ratio of 1.75:1. Both models are at 60° after the TDC point.

FIG. 15 is another sequential schematic operating diagram of the VR/SR mechanical concept compared with the conventional model, both using square bore to stroke ratio and the same Rod to Stroke Ratio of 1.75:1. Both models are at 90° after the TDC point.

FIG. 16 is a scammer illustration of an ECVC and slow motion of the piston set (2) to appear at the BDC point. The system provides an increased crank lever throughout upstroke and downstroke until 105° ATDC.

FIG. 17 is a sequential 2D view of one orbital-epicycle crank throw with VR/SR operation and assembly parts where per disclosed principles the ECVC is set to appear at the BDC point.

FIG. 18 is the assembled crank throw elements per disclosed principles from FIG. 17.

FIG. 19 is a cut-away view of a single orbital-epicycle crank throw with contents as follow: helical sun gear with collar style 6, orbital planetary gear 5, orbital journal 4, main shaft 7, counterweights 7a, block wall 18, oil film bearings 19, excess mass for removal 20, oil galleries 21, orbital shaft axis 22a, and main oil supply 25 per an embodiment of the disclosed principles.

FIG. 20 is a sequential 2D view of an ICE engine using VR/SR crankshaft per an embodiment of the disclosed principles, where the ECVC and slow motion of the piston is set to appear before and after the BDC point. Both models are at the TDC point.

FIG. 21 is another sequential 2D view of an ICE engine using VR/SR crankshaft following the embodiment of the disclosed principles, where the ECVC and slow motion of the piston is set to appear before and after the BDC point. Both models are at 30° after the TDC point.

FIG. 22 is another sequential 2D view of the engine concept using VR/SR crankshaft following an embodiment of the disclosed principles, where the ECVC is set to appear before and after the BDC point. Both models are at 60° after the TDC point.

FIG. 23 is another sequential 2D view of the engine concept using VR/SR crankshaft following an embodiment of the disclosed principles, where the ECVC is set to appear at the BDC point. Both models are at 90° after the TDC.

FIG. 24 is another sequential 2D view of the engine concept using VR/SR crankshaft following an embodiment of the disclosed principles, where the ECVC is set to appear at the BDC point. Both models are at 120° after the TDC with open uniflow scavenging exhaust ports.

FIG. 25 is another sequential 2d view of an engine using VR/SR crankshaft following an embodiment of the disclosed principles, where the ECVC is set to appear at the BDC point. Both models are at 150° after the TDC point.

FIG. 26 is another sequential 2d view of an engine using VR/SR crankshaft following an embodiment of the disclosed principles, where the ECVC is set to appear at the BDC point. Both models are at 120° before the TDC point with closed uniflow scavenging exhaust ports.

FIG. 27 is an exploded 3D illustration of a disassembled paired orbital-epicycle crank throw with split orbital-epicycle crank pins separated with sway angle of 180° around the center of the orbital shaft in a horizontal 4-cylinder embodiment of the disclosed principles.

FIG. 28 is an assembled 3D illustration of the orbital-epicycle crank throw with ECVC and the slow motion of the piston is set to appear before and after the TDC implemented in a horizontal 4-cylinder embodiment of the disclosed principles.

FIG. 29 is a schematic view of a complete orbital-epicycle crankshaft for a horizontal four-piston concept with VR/SR operation.

FIG. 30 shows the operation of a horizontal engine embodiment with paired crank throws and split orbital-epicycle pins creating even firing intervals of 180° and firing order 1-2-3-4, also all mechanical elements are inherently balanced.

FIG. 31 captures a moment of an operation of orbital-epicycle crankshaft while power piston engaged with an advanced relationship has considerable higher cylinder pressure with piston 83 (according to comparable scaler 44 provided above the cylinder to the left) while the compression cylinder either 84 or 87 will already come to the end of its own reciprocating motion and not requiring any more force to complete the hardest 30 of its compression stroke.

FIG. 32 V6 configuration with an orbital-epicycle crank throws 38a, 39a and 40a are radially opposed every 120° around main journals and orbital-epicycle pins 4 are offset in the direction of the engine rotation every 120° around the center of the orbital shaft 22a. Power piston 1v is at 30° ATDC point and exiting the ECVC cycle while piston 6v is still at its 150° of a power stroke thus creating a power overlap of 30° where the compression piston 2v shows a higher level of its compression state at 90° with scaler 45 (VR/SR) vs scaler 44 (Conventional)

FIG. 33 is a sequential illustration of an orbital-epicycle crankshaft in V120° engine configuration followed by an embodiment of the disclosed principles. It shows how power piston 1v with at least twice higher cylinder pressure 62 is handling compression cycle with piston 2v with a lot less effort.

FIG. 34 is a sequential schematic illustration of an orbital-epicycle crankshaft in V120° engine configuration by an embodiment of the disclosed principles. Further shows how power piston 1v with still considerably higher cylinder pressure 62 has brought the compression piston 2v to the end of its reciprocating motion and entered into the ECVC cycle.

FIG. 35-38 shows an alternative VR/SR OPOC quadrangle engine concept, where the ECVC cycle and slow motion of the pistons is appearing at DBC points and its implementation in opposed piston opposed cylinder layout, two-cycle with a uniflow scavenging system where the exhaust and intake port are located around BDC. Further with unique arrangement of crank throws and alteration of the length of the common cylinder orders the piston A and B to follow another for 30° which produces a constant volume cycle in duration of 30°. Flywheel 33b, 34b, 37b and 38b have the same pitch diameter and each are part of individual crankshafts A3, B3, C3 and D3 meshed with central gear g1 without a strict ratio.

FIGS. 39-41 shows another alternative VR/SR OPOC four-cycle quadrangle engine concept with ECVC cycle and slow motion of the pistons are set to appear before and after the TDC. Crank throws are in a specific offset position to produce ECVC at TDC in crank duration of 60°. The conventional crank mechanism has a lack of time at TDC and increases the volume too fast after the TDC, by conventional OPOC engines that rate is twice increased, thus this alternative way presents a way to resolve that issue. Further flywheels 41b, 42b, 43b, and 44b are the same diameter and are one part with individual crankshafts 41a, 42a, 43a and 44a and are meshed with central gear g2 in a ratio of 0.5-1 in order to provide a right speed of the camshafts mechanism located in the middle of the g2 for controlling the intake and exhaust gasses.

### DETAILED DESCRIPTION

Before presenting a fuller discussion of the disclosed principles, an overview is given to aid the reader in understanding the later material. As noted above, a constant radius eccentric pin system as is used in ICE has numerous disadvantages, especially concerning the piston's movement around TDC and the piston to crank relationship after the TDC and around the BDC point. The piston to crank relationship has a direct impact on the level of extraction and conversion of energy from the thermodynamic process.

In general, these problems include complex charging requirements, inefficient combustion, complex injection, sophisticated combustion management systems, many of the after-treatment accessories, and techniques to support further fuel atomization of extra reach mixture intentionally created to slightly raise the thermal efficiency.

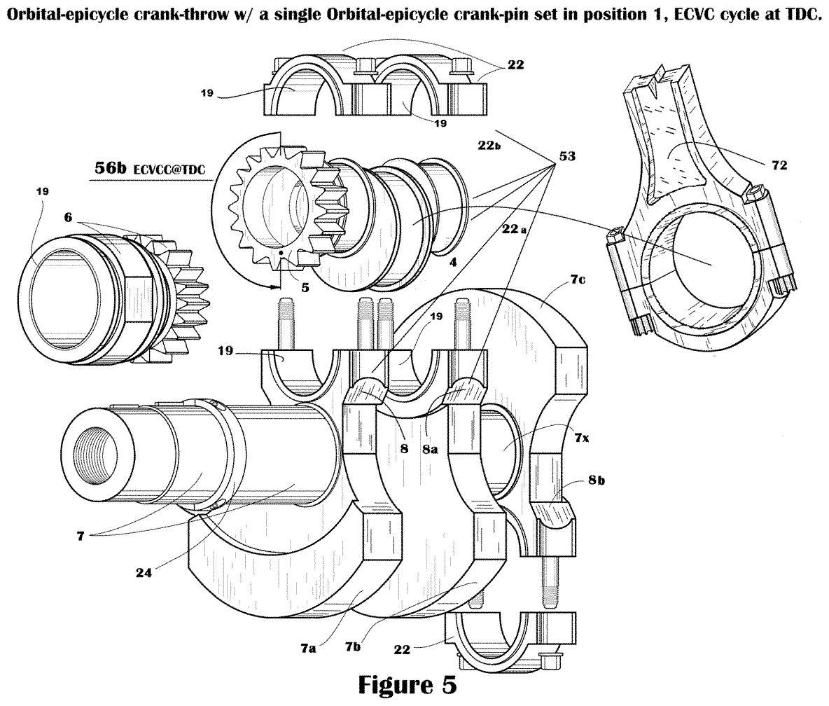

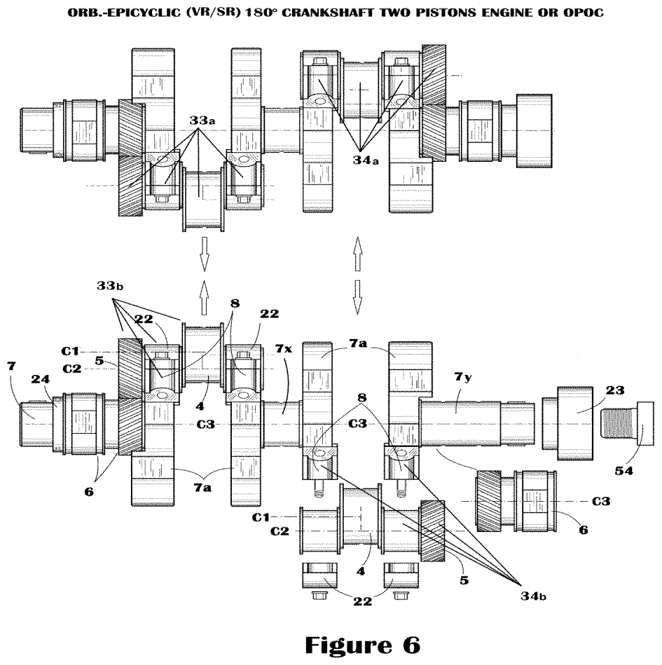

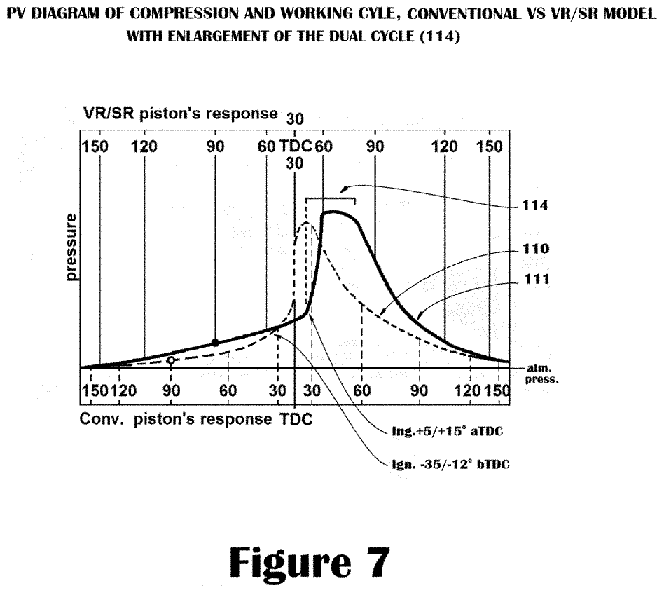

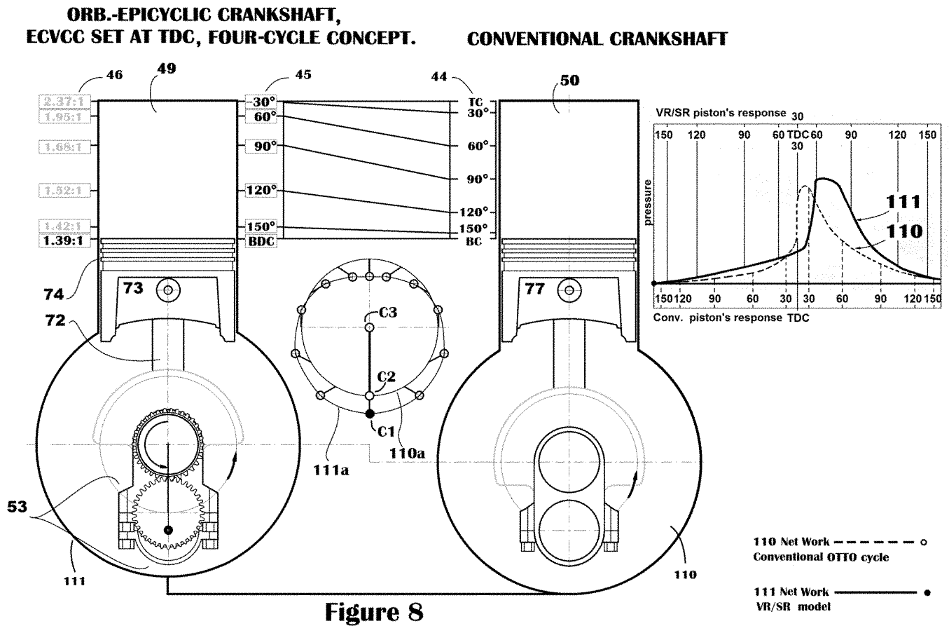

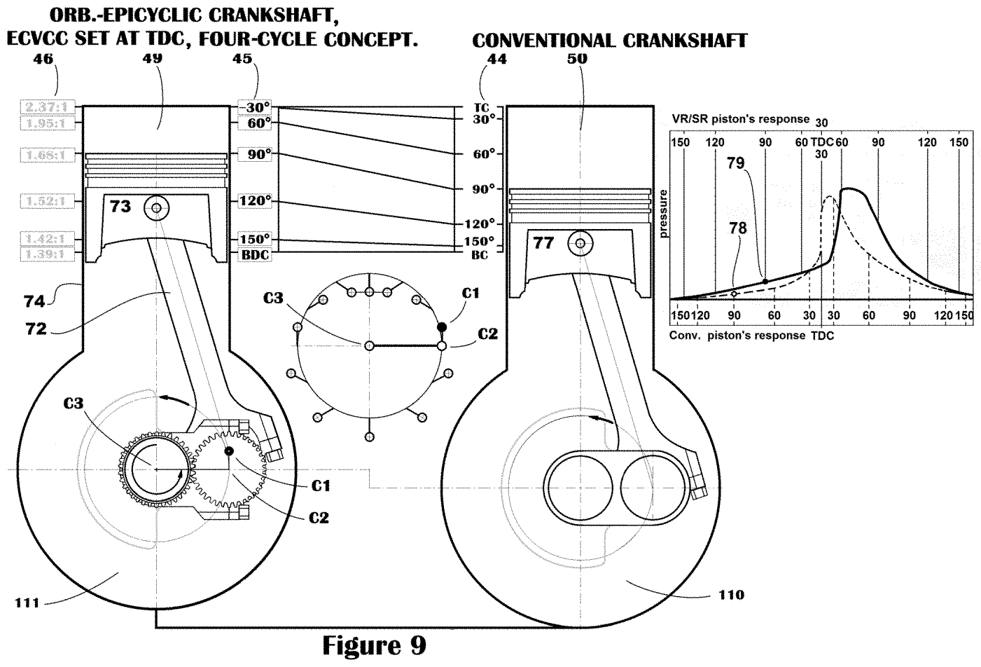

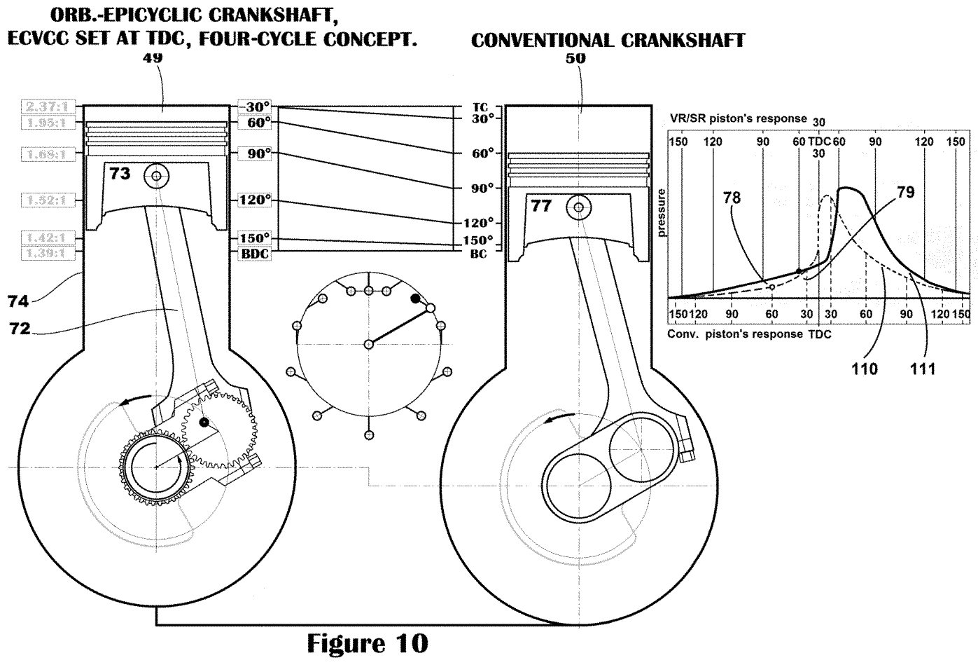

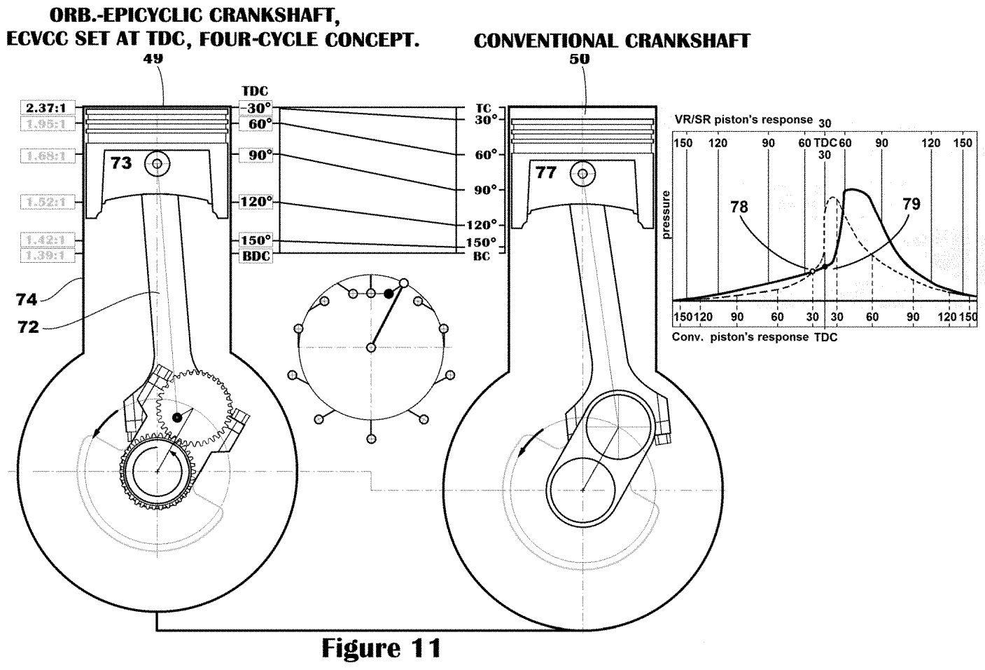

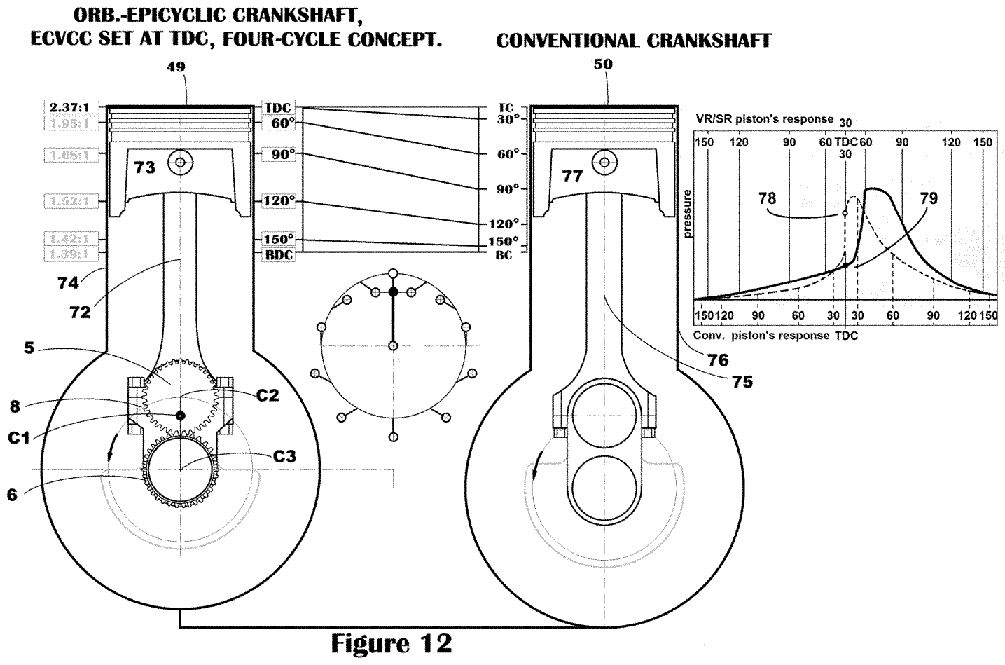

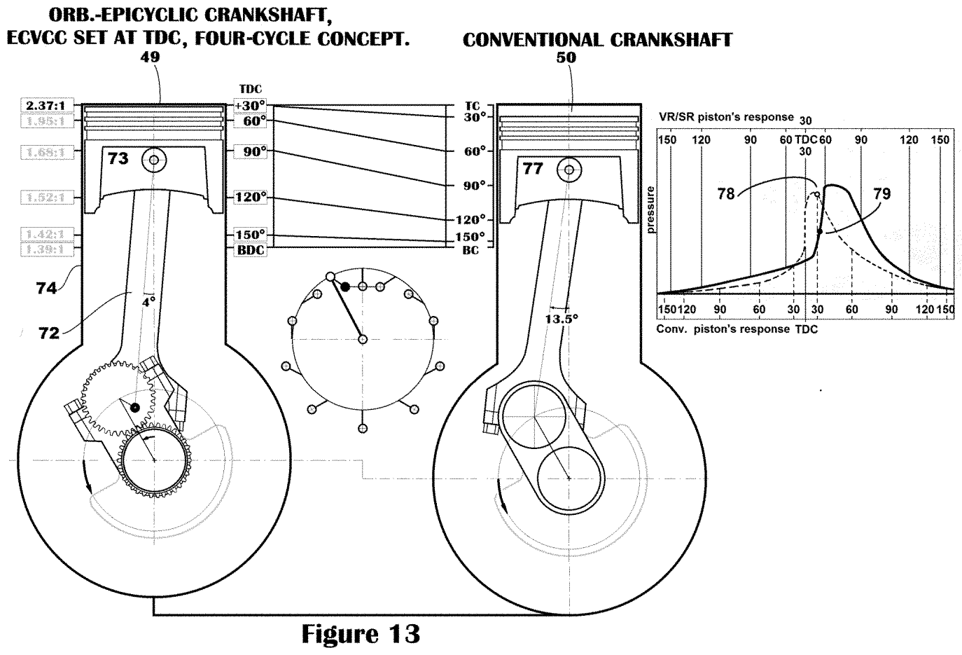

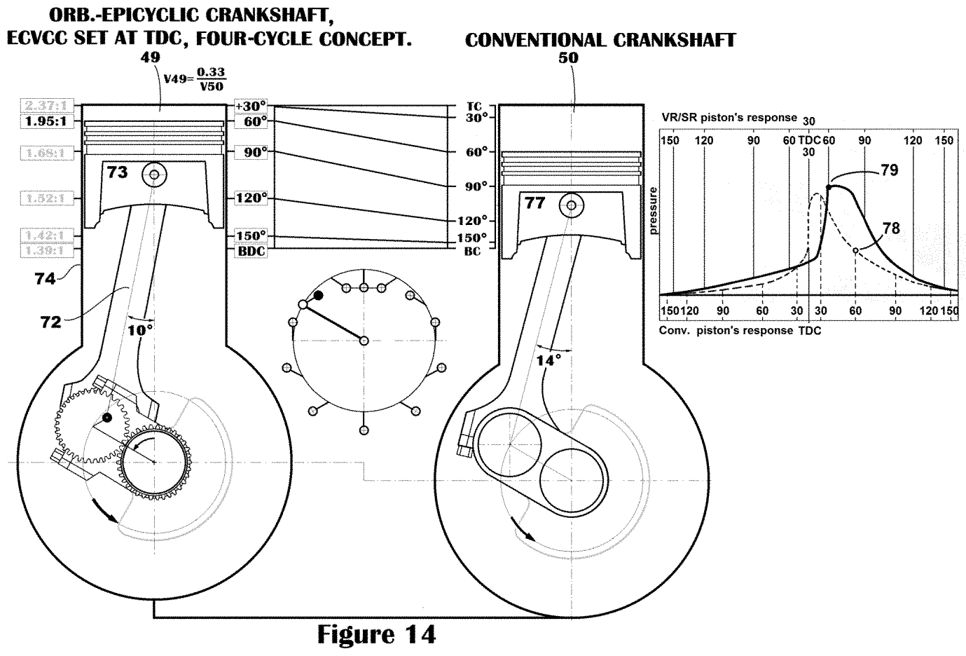

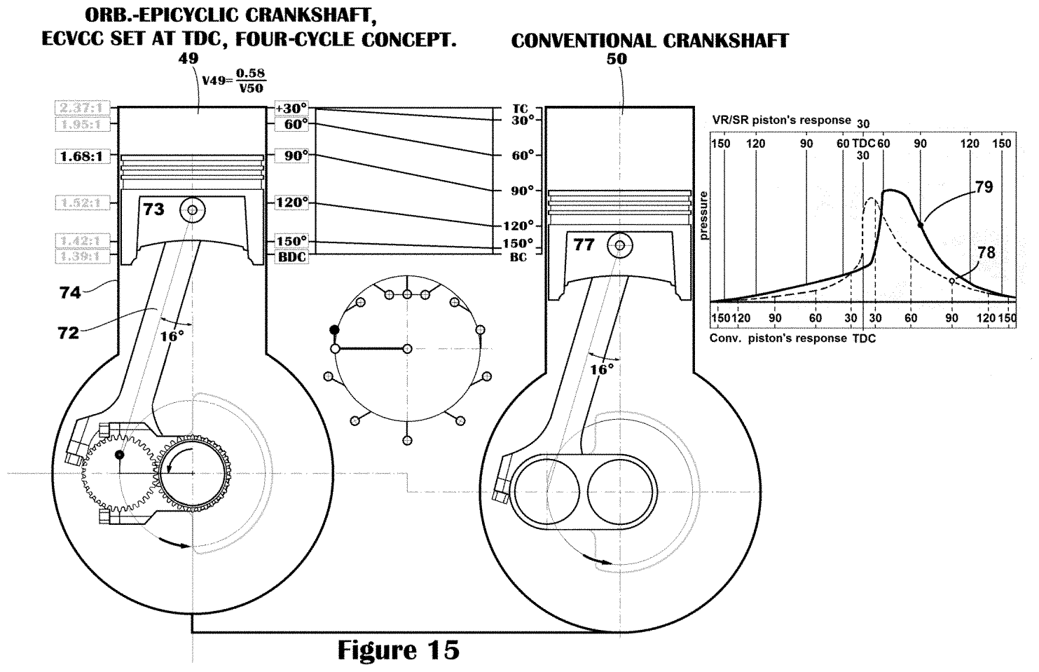

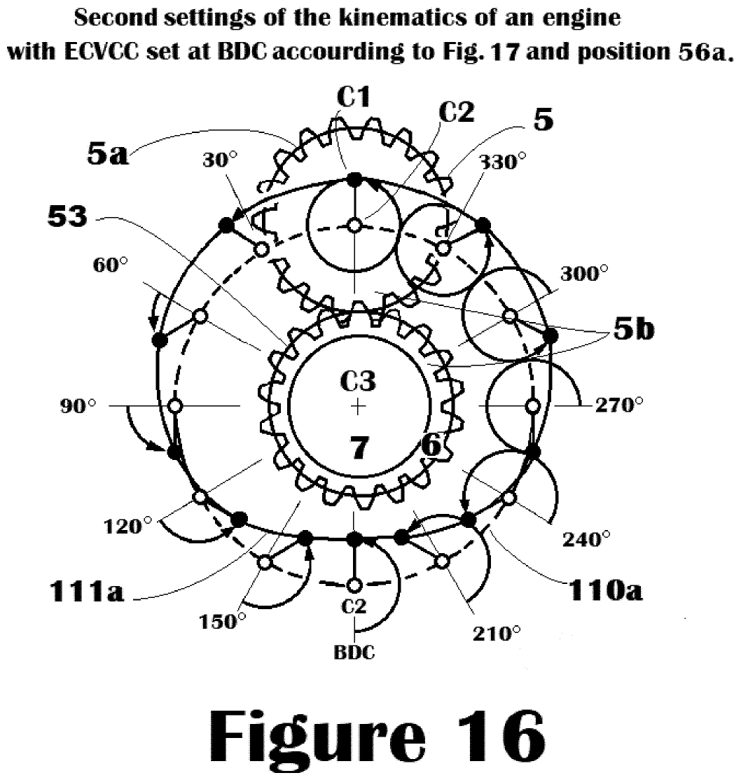

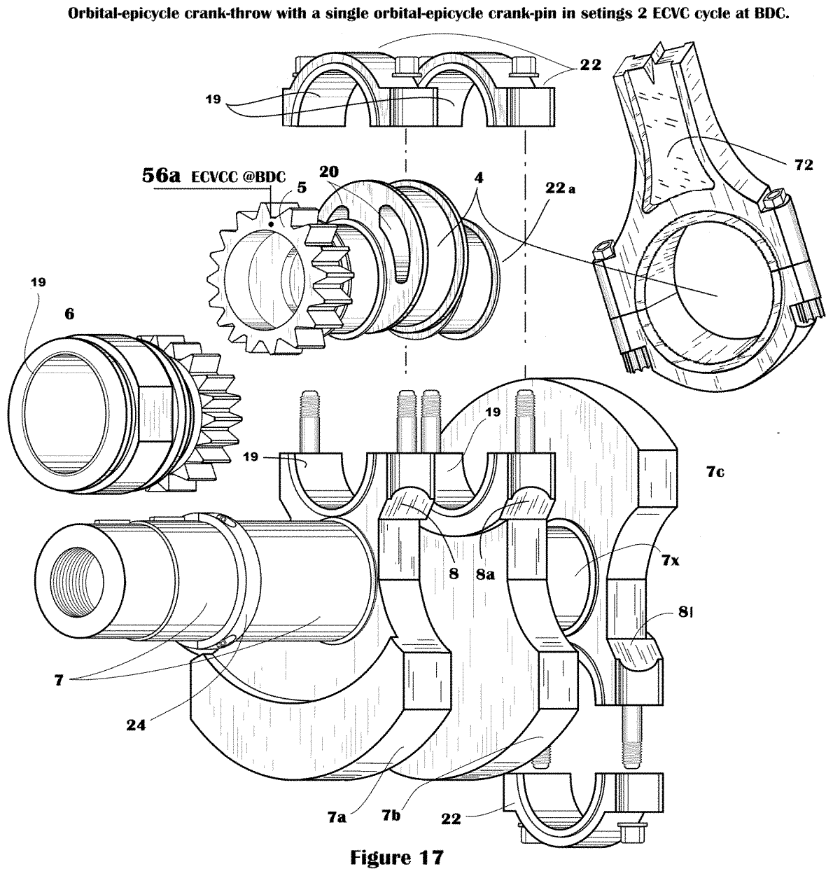

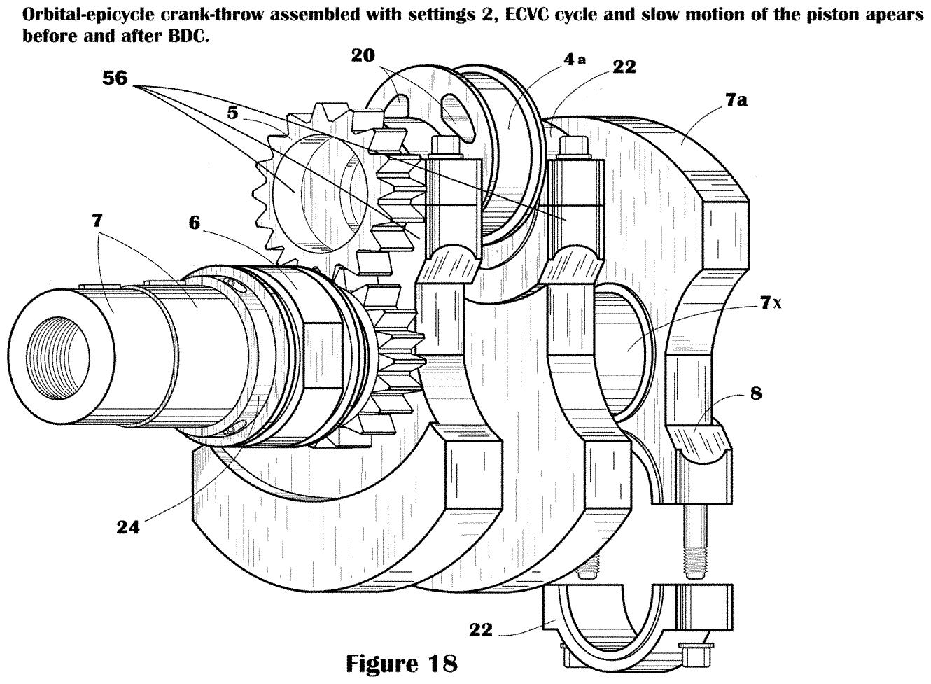

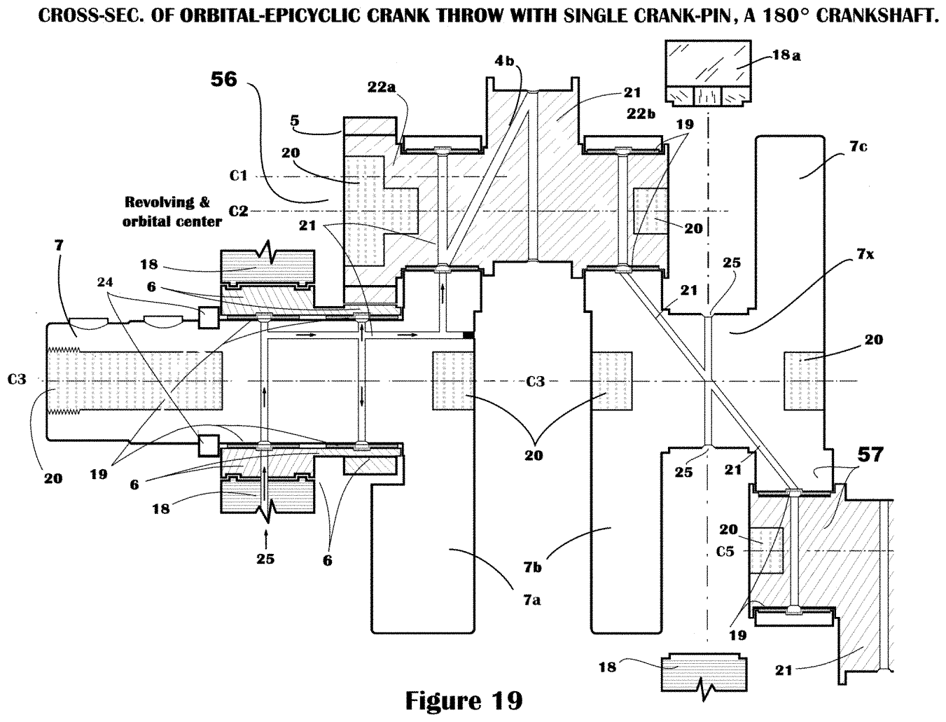

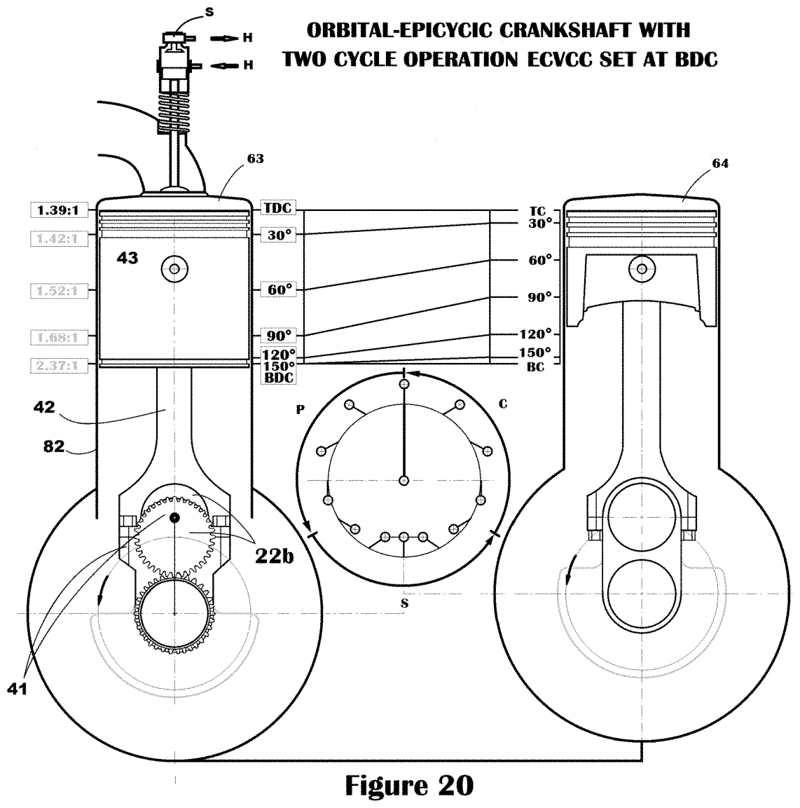

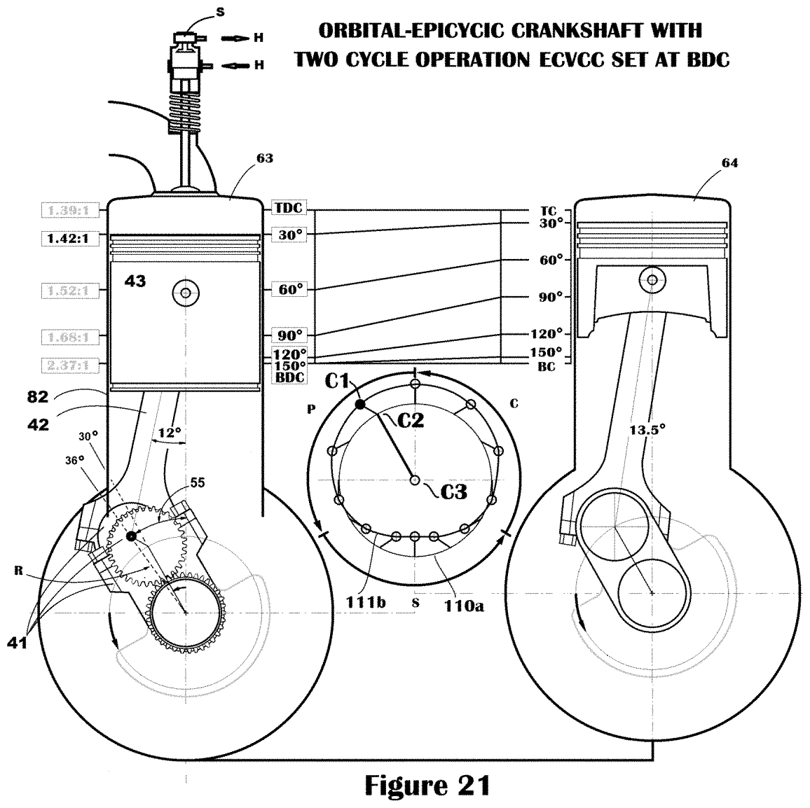

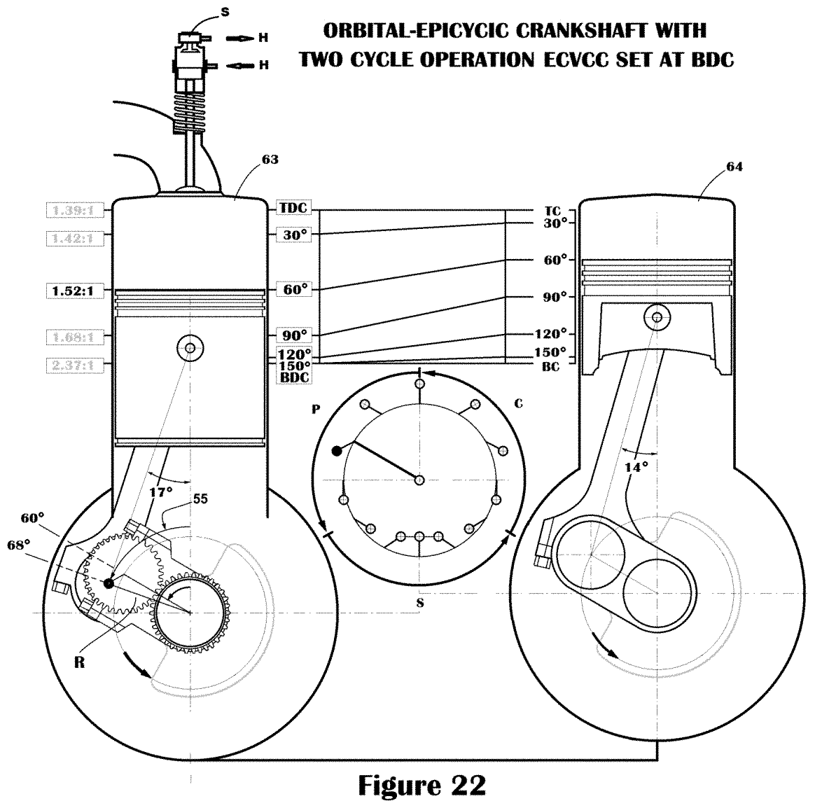

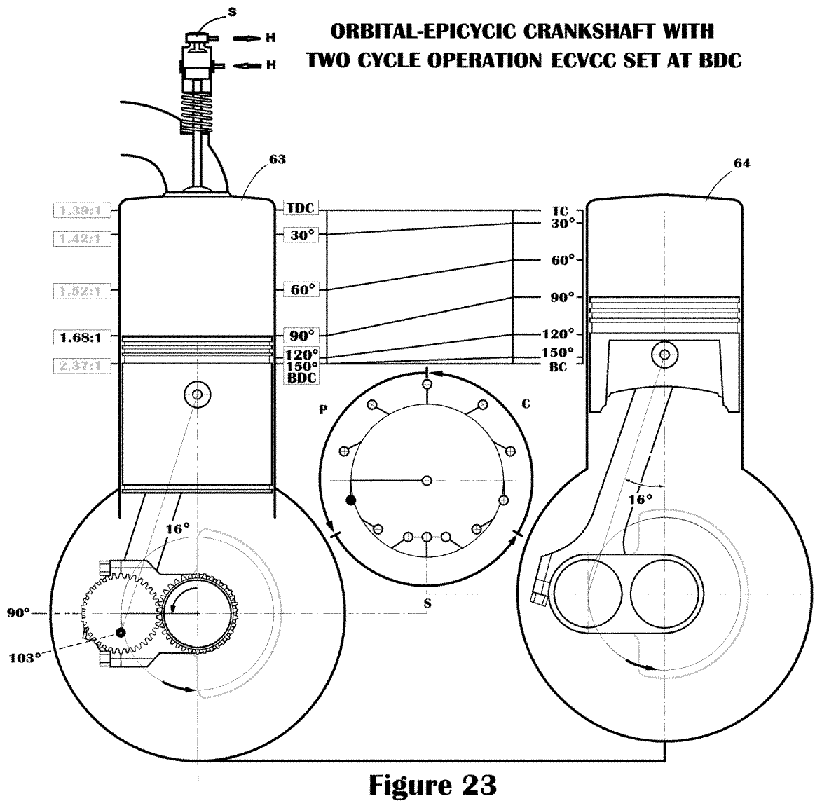

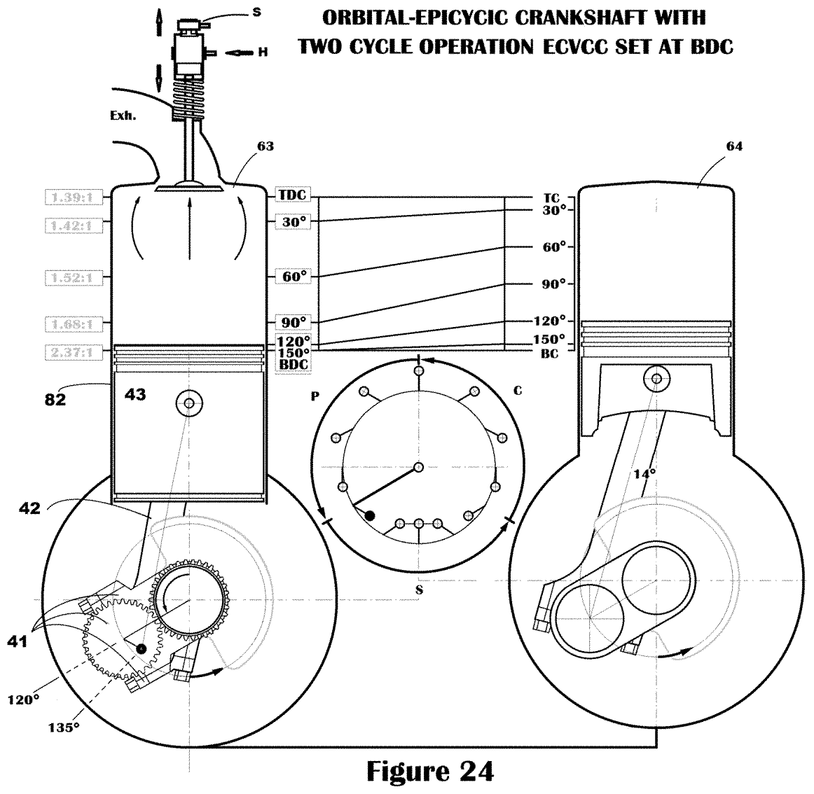

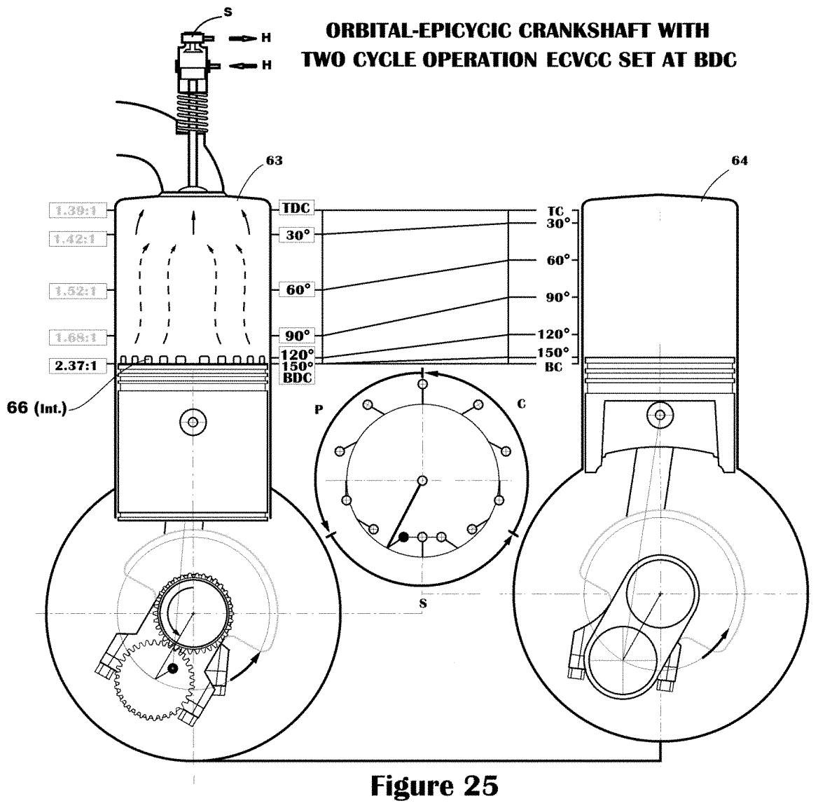

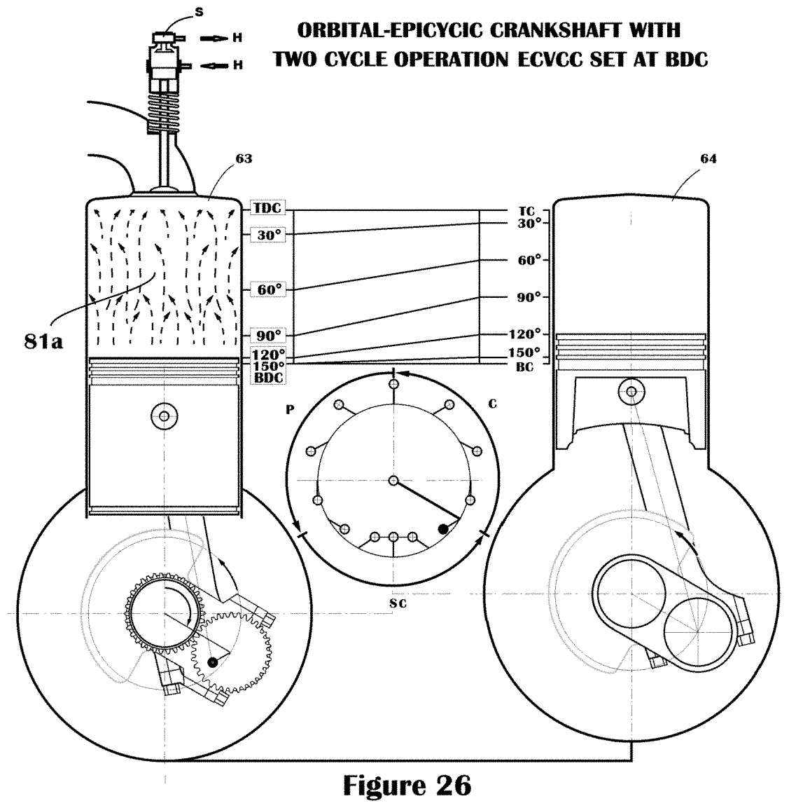

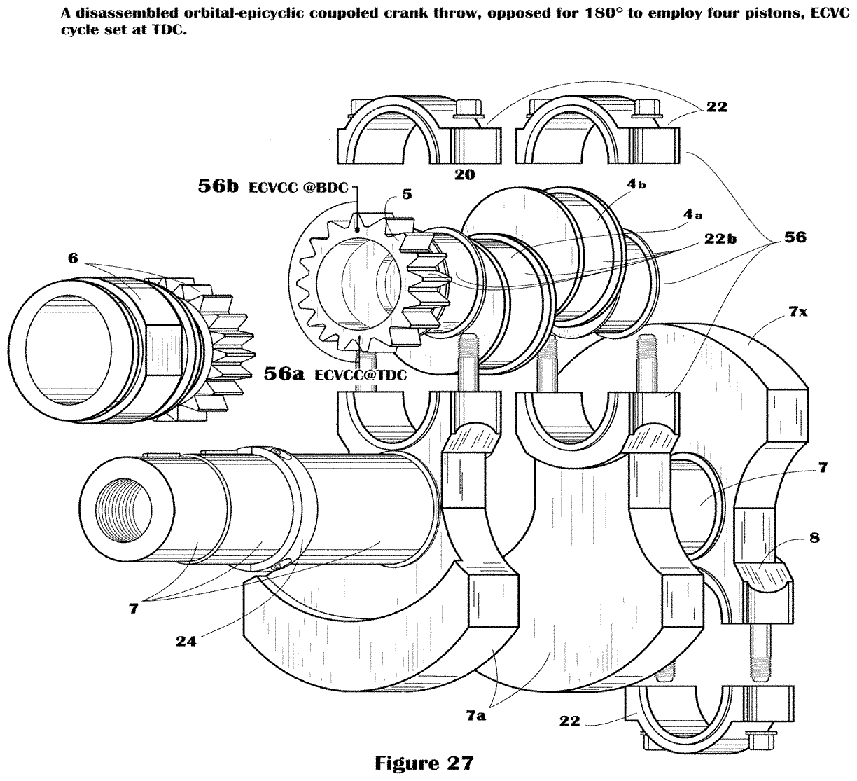

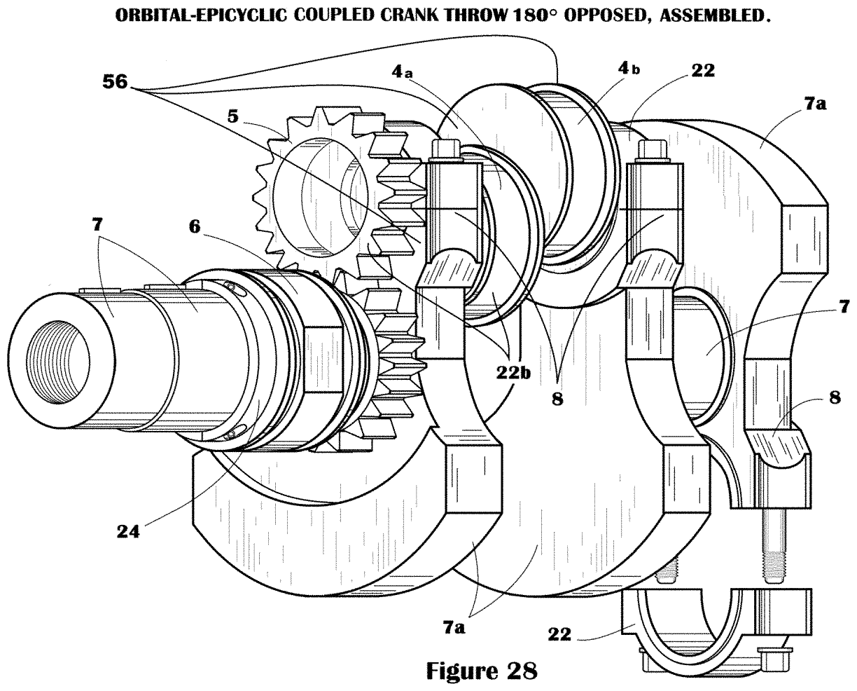

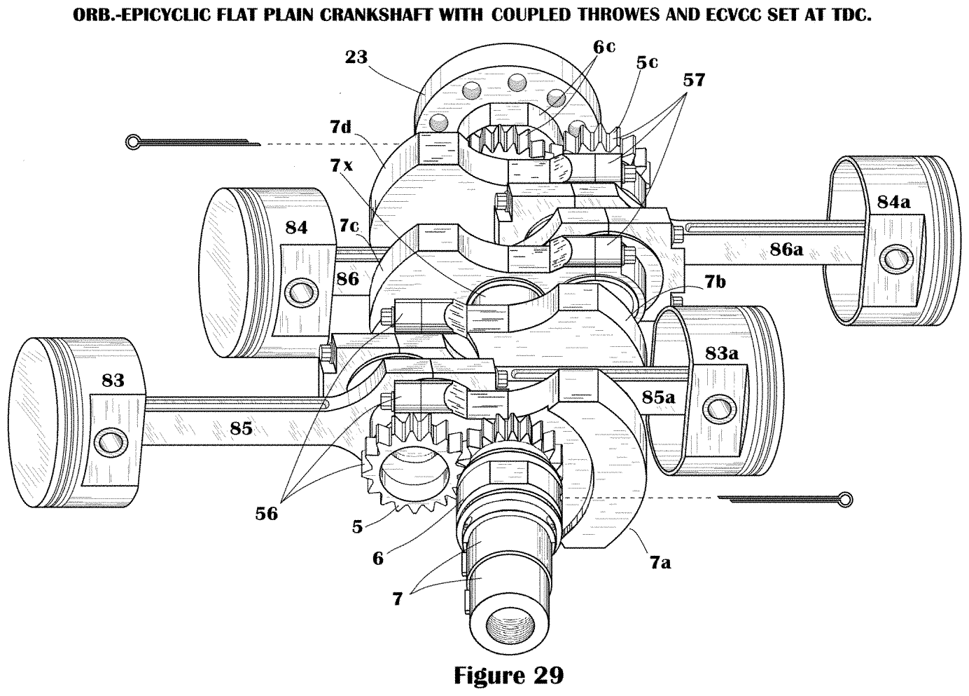

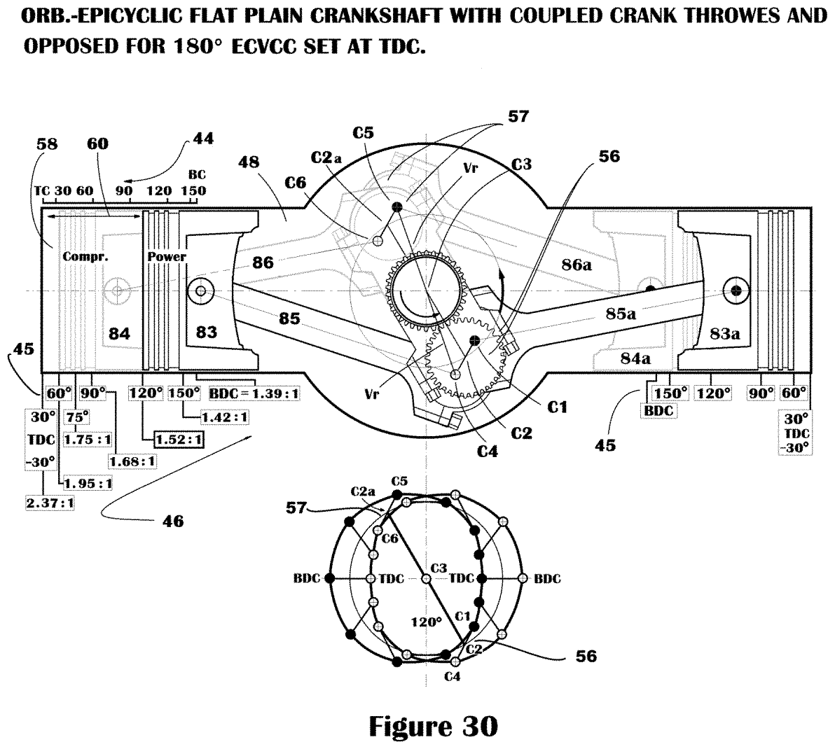

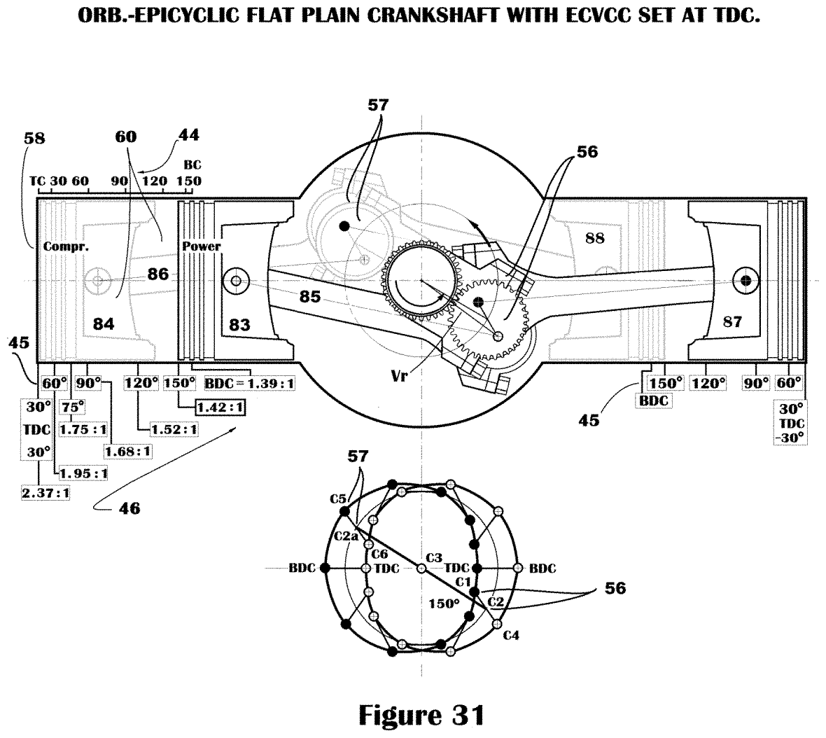

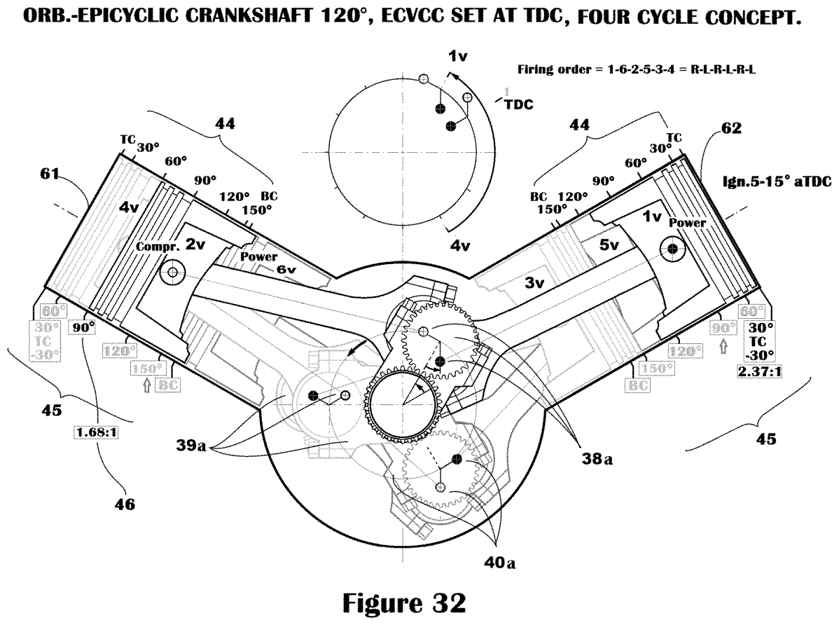

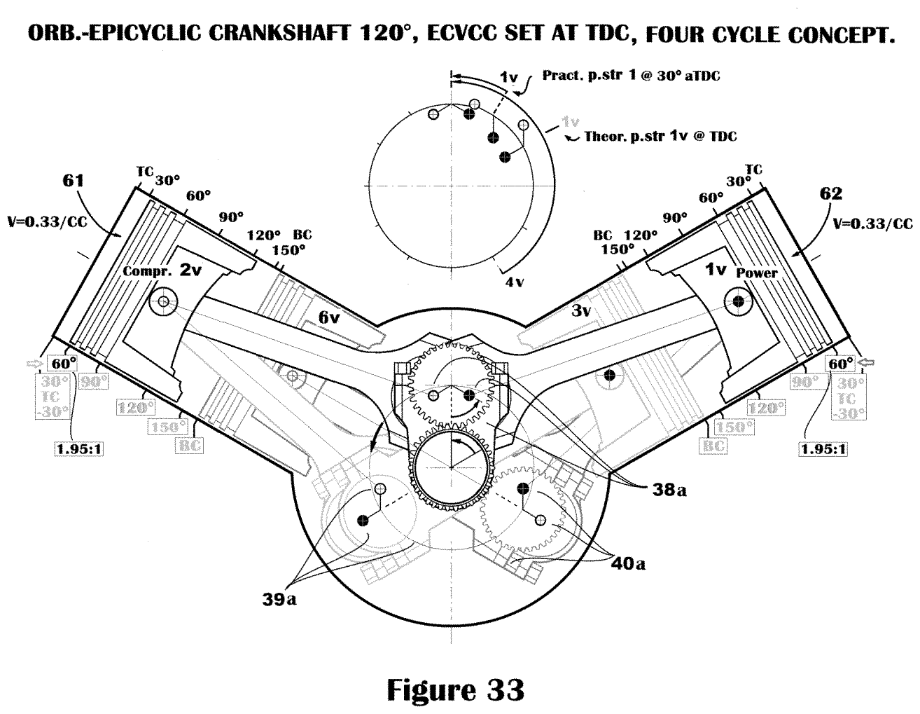

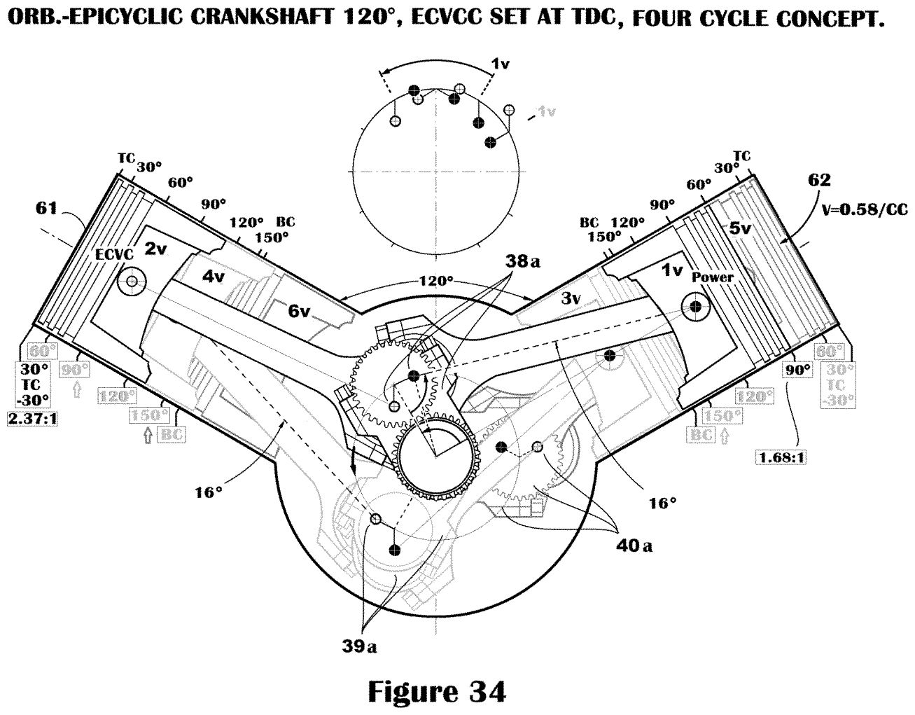

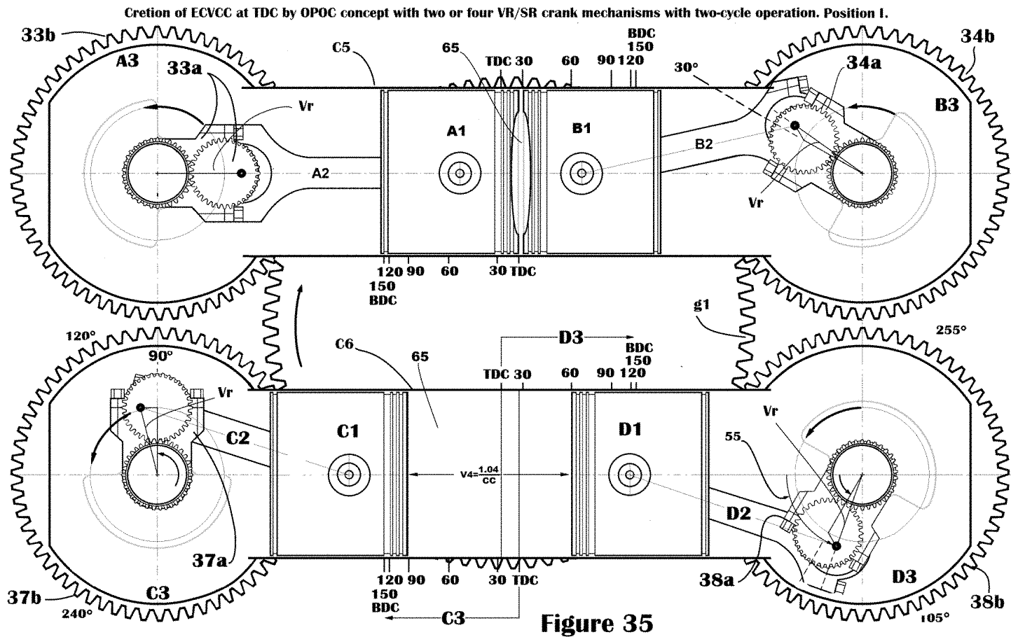

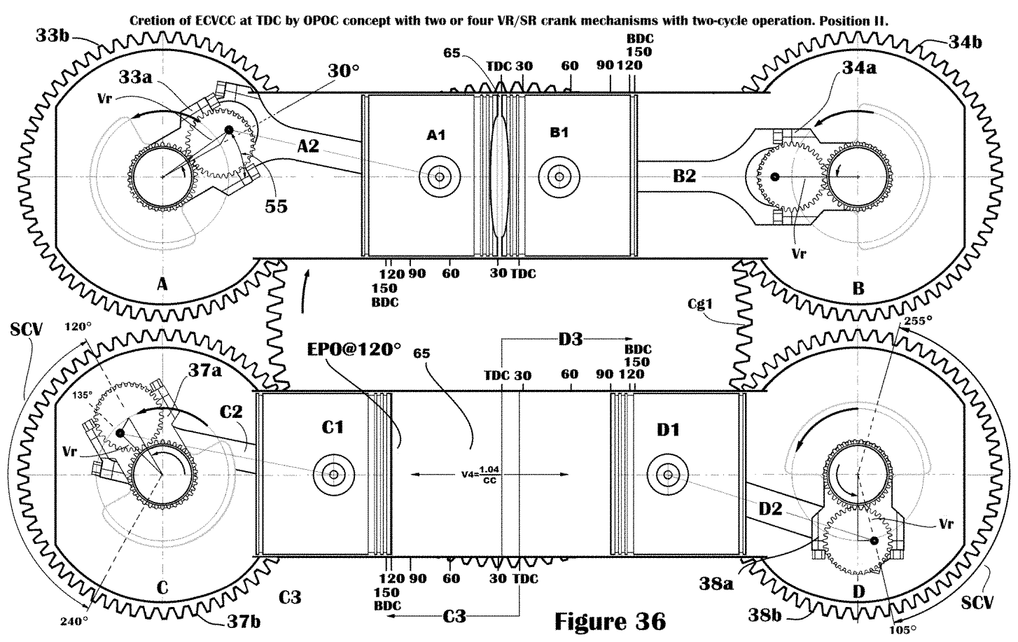

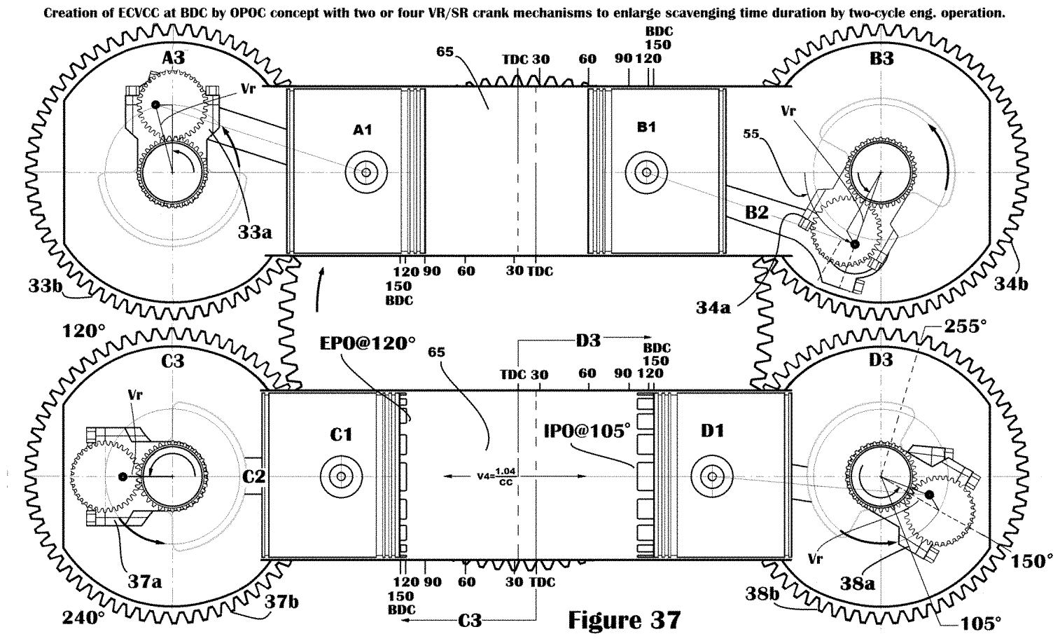

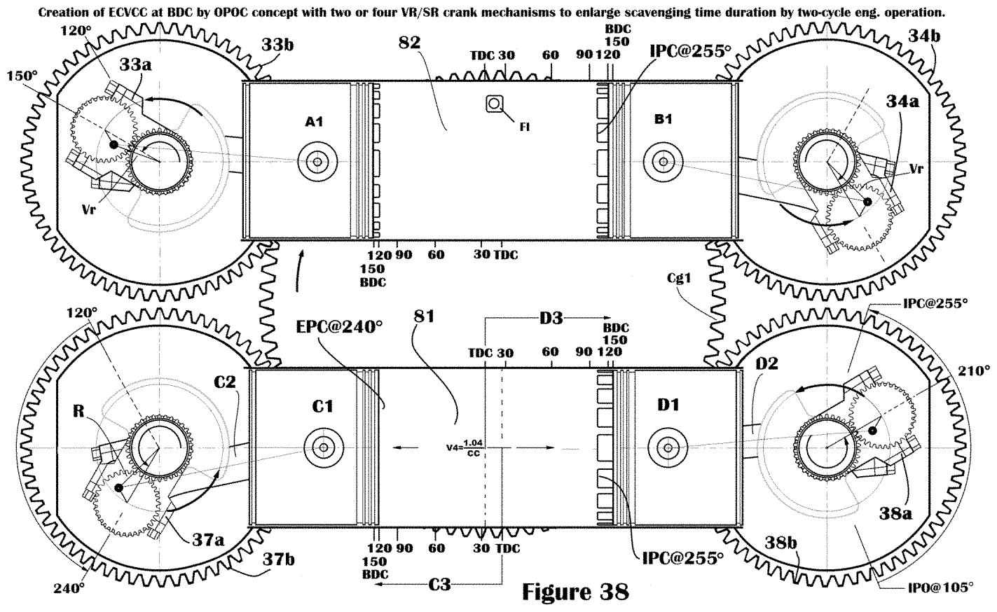

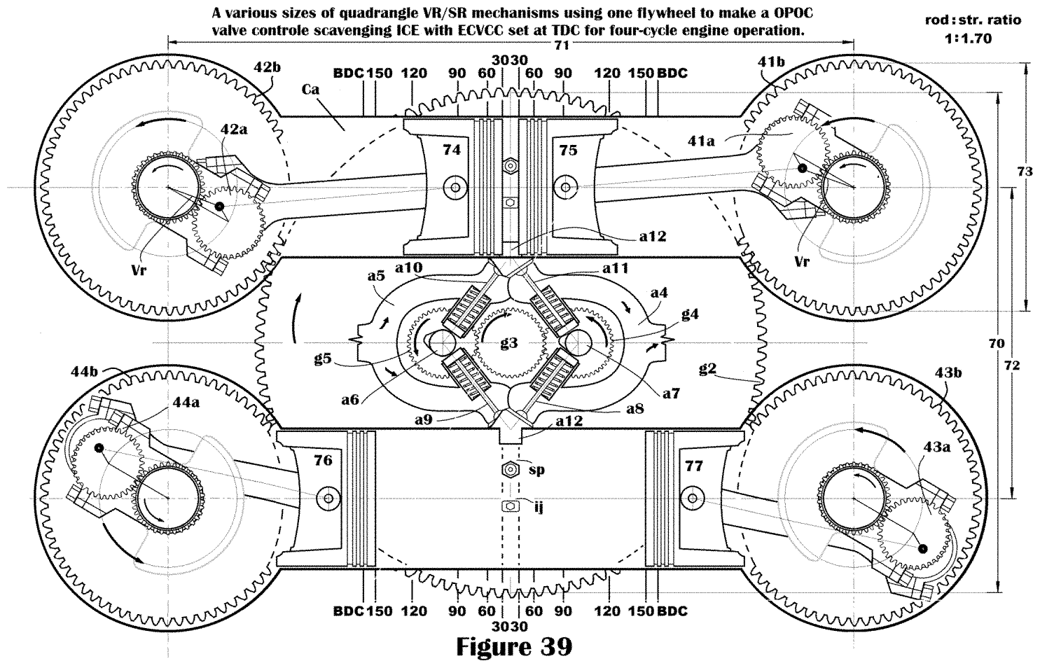

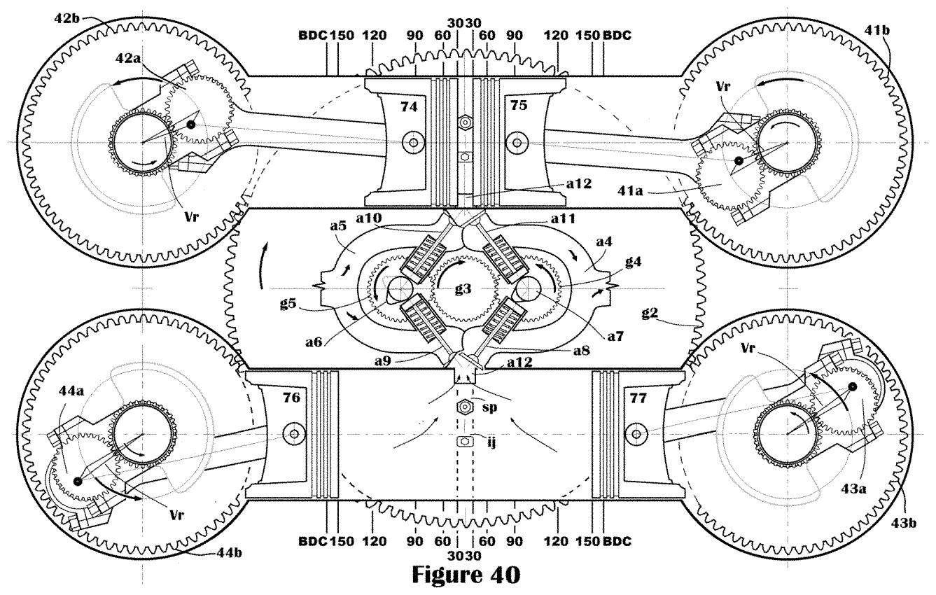

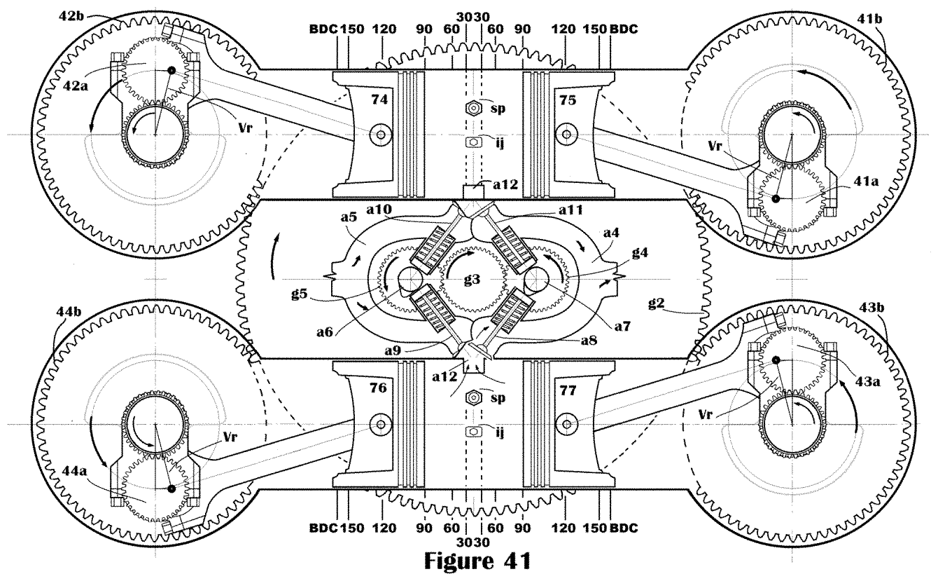

However, the invention in certain embodiments with ECVC cycle and slow motion of the piston appears before and after the TDC, settings 1 in FIG. 5 with 3D view, allows the combustion in the chamber to be held at a constant volume at and around TDC up to 60°. This feature prolongs the period during which effective ignition and combustion after conventional TDC can take the place, postponing the pick cylinder pressure to accrue at around 60° leading to greater thermal efficiency, reduction of operational energy, reduction of flow by gasses during the increase of the load, and reduction of lateral stress to mechanical joints. Operational cycle demonstrated in animated FIGS. 8-15.

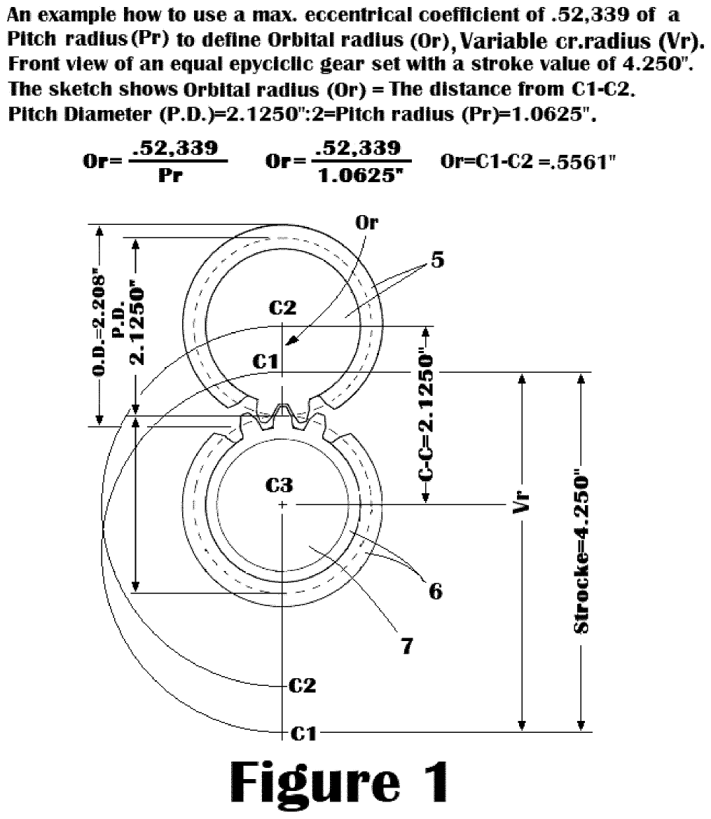

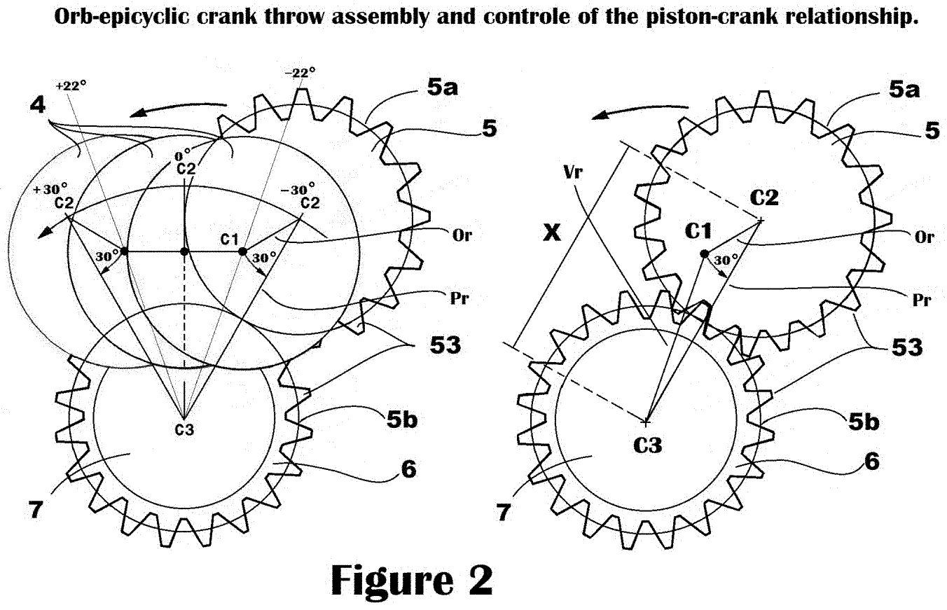

The schematic diagram of FIG. 2 shows a partial epicyclic motion of the orbiting rod journal system following an embodiment of the disclosed principles. As can be seen, this embodiment includes a planetary gear 5 together with an orbital shaft and orbital journal orbits around C2 as revolving and orbital center at a constant distance around the center C3. While C1 simultaneously orbits around the revolving and orbiting center following an epicyclic motion around the stationary collar style, the sun gear creates an irregular path. The same FIGS. 1, 2, and 3 show how the orbital journal with center C1 is offset from the center C2 at a distance of 0.52339 of the pitch radius 5a. Starting from 30° BTDC further following epicyclic motion to 30° after TDC can create an almost straight line if coupled with the identical stationary sun gear, pitch circle. The crank elements in this embodiment extend the constant volume combustion period (EDDUR) up to 60° of crank time duration. This presented piston to crank mechanical relationship is subject to adjust depending on the fuel characteristics and the engine efficiency requirements. As shown in FIGS. 1 and 2 the epicyclic gear set involves two gears with identical pitch radius and OD. Orbital pin C1 can be set at a greater or lesser distance from the center C2 (orbital shaft 5), directly affecting the piston's response to crank angular motion. For example, reducing the offset distance slightly increases the piston's speed before and after TDC and subsequently decreases the piston's speed before and after BDC, very importantly reducing the constant volume combustion duration. Further, increasing C1 offset from C2 beyond this point (disclosed in paragraph 29) will cause the piston to dip toward the main shaft at TDC, momentarily decreasing then again increasing the compression volume and seriously interrupting accumulated angular momentum, simultaneously increasing the lateral stress onto the mechanical joints.

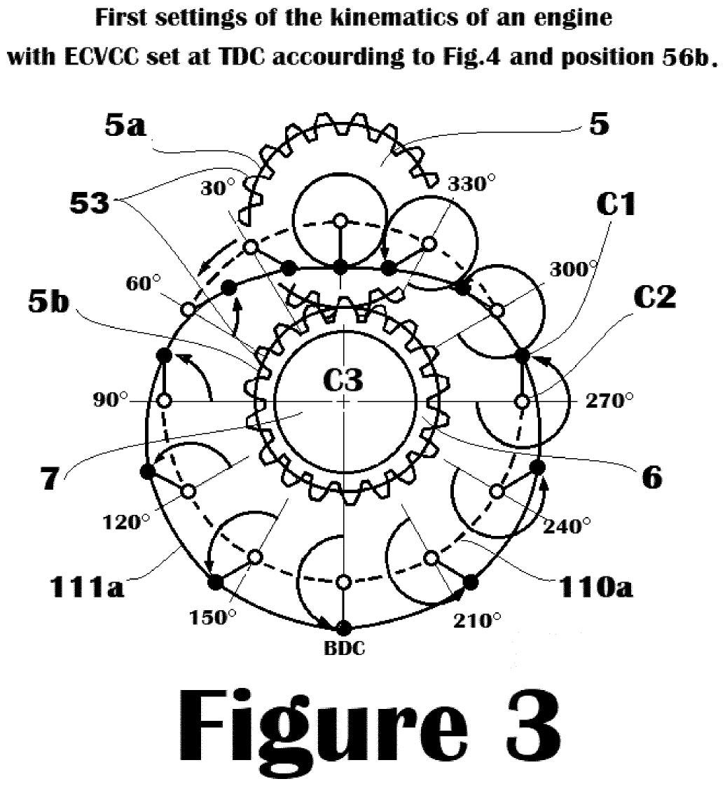

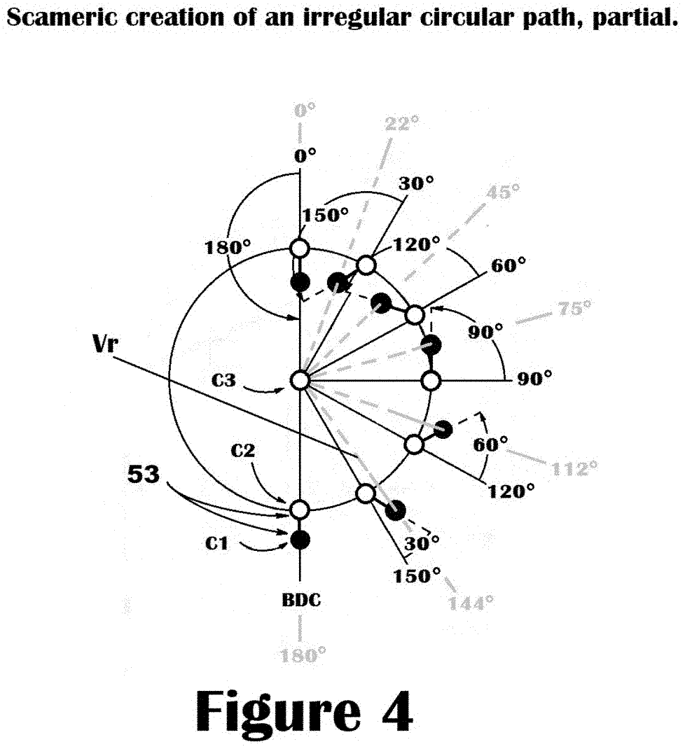

In greater detail of FIG. 4, the geometrical behavior of the orbital pin C1 can be seen in terms of how it is exiting out of circular motion; when the engine revolves, the pin orbits together with planetary gear 5 around C2 position itself at 150° while the C1 is at 144° to the main center of rotation C3. When the planetary gear C2 is at position 120° the orbiting journal C1 will be at 112°. When the C2 is at 90° crank position the C1 will be at 75° to the main center of rotation C3. When a C2 position is 60° the C1 is at 45°. When the C2 is at 30° the C1 will be at 22° to the main center of rotation C3. When the C2 is at 0°, the C1 will be also at 0°, but due to simultaneous orbital and revolving motion (epicyclic motion) positions itself as it rotated for 360° around the main crank journal 7 and C3.

In FIGS. 8-15 the details of comparable animation in between VR/SR concept 111 which lies to the left and conventional 110 are shown to the right. For this demonstration, the planetary gear 5 with a shaft and orbital-epicycle crankpin is engaged with stationary sun gear (collar style), and the ECVC (EDDUR) appears at TDC to improve the four-cycle engine operation. Throughout a single and complete epicyclic motion of the engaged gears, the C1 as the center of the orbital crankpin is veering in the distance from main shaft center C2, changing the effective diameter of the crankshaft. Subsequently, C1 creates and follows an irregular but most importantly vertically symmetric circular path. C1's epicyclic behavior creates VR/SR (variable rod-stroke ratio throughout a single rotation), and the scaler is conveniently displayed on the left side of the cylinder starting at BDC with 1.39:1 and ending at TDC with 2.39:1. Both diameters of the crankshafts can be compared at 75° where the conventional perfect circular path also presented on model 111 intersects with the irregular circular path, both models then use the same crank diameter/stroke and length of connecting rod followed by an embodiment of the disclosed principles. The scalars above the center drafts are horizontally lined and both concepts are animated with 30° rotational increment. This modifies two or four conventional cycles to 150° crank time duration in that it a) creates an ECVC (EDDUR) cycle around TDC & or at BDC with adjustable time duration, b) corrects inadequate piston to crank relationship around TDC or BDC, c) If used in four-cycle concept, provides ECVC cycle in between exhaust and intake cycle as well, where the intake valve could open @ 30 before TDC improving volumetric efficiency by forced induction, d) creates a dynamic compression cycle of ⅙ shorter than conventional piston-crank time duration thus secures the charge of a knocking phenomenon.

The system for four-cycle engine operation as seen in FIGS. 8-15 a VR/SR model at 60° provides volumetric displacement only 0.33:1 vs. conventional, further at 90° only 0.58:1 and at 120° devalues the pressure 0.80:1, at 150° still lower at 0.95:1. The figures clearly show how cylinder 1 based on specific volume after TDC up until 105° is in an advanced position with cylinder pressure vs. conventional model. For instance, the volume at 60° of VR/SR cylinder 1 under scaler (45) is equal to 0.33:1 vs. conventional mode (44). Based on the specific volume at this particular angle and if combustion is equally managed, considering that volume is in an opposed equation with pressure and heat it is expected to have at least twice a higher pick pressure. According to another kinematic of the V120° epicyclic crankshaft demonstrated in this animation; while the piston 1 is at its own 90° with noticeable higher cylinder pressure at this state of the power stroke, the piston in cylinder 2 is already in the ECVC cycle.

Further, the invention presents another cinematics of the engine, settings 2, by reversing the orbital shaft 22a according to FIG. 17 and position 56a with ECVC cycle and slow motion of the piston to accrue before and after the BDC. Operational cycle has shown in the FIGS. 20-26.

This two-cycle model with a uniflow scavenging system has reduced the expansion cycle to 120° of the angular duration after TDC labeled as ‘P″. A hydraulically controlled valve opens and depressurizes the cylinder at 120° and closes it at 130° while the intake ports are exposed simultaneously. The remaining crank rotation from 130°-240° is reserved for an extended scavenging time duration to boost the efficiency and is labeled with “S”. The compression stroke starts at 240° and ends at TDC labeled as “C”. The animation presents only an alternative way of opening the exhaust valve by hydraulic means as seen on today's large marine two-cycle engines. This mechanical concept with extra-long but adjustable scavenging time duration brings several advantages: a) increases the volumetric-scavenging efficiency, b) decreases the mechanical energy needed to provide high pressure which has to enter the cylinder throughout extremely short time duration by a conventional concept, and c) As a result of the two characteristics above allows the engine to operate at higher RPM. The novel engine concept provides new dynamics of the crankshaft which can be used as well with the “crosshead element”. This may increase the RPM of the engine and appreciably increase the power.

Turning to FIGS. 30-31, a horizontal four-piston concept with paired orbital-epicycle crank throw with split orbital-epicycle crank pins separated by a sway angle for 180°, (Dual VR/SR operation is shown). This figure shows the operation of a horizontal engine embodiment with a new layout of the regrouped pistons involved in a reciprocating motion. Opposed orbital journals horizontally used in flat plane fashion still keep all mechanical elements in an inherently balanced position. Two or more such assemblies may be stacked to employ a higher number of cylinders. The same figure has omitted the positions of counterweights for clarity of the draft. Contents of the figure are; Variable rod to stroke ratio scaler related to specific crank angular motion 46, connecting rod and piston at 120° in expansion cycle 47, volume and cylinder pressure created with new mechanical engagement versus a conventional model with scaler above the left cylinder 49, connecting rod and piston of compression stroke 48. The image shows the higher level of the compression stage achieved under volume 50 while the power piston is holding lower volume under 49 equal to 0.80 of volume 50. Due to the slower volumetric increase from 30° ATDC to at least 105°, more time is given for better fuel propagation and a higher level of atomization. Figure emphasizes only one position of the crankshaft while the engine is finishing the compression cycle. Further, the specific position of the crank elements demonstrates how it doesn't require a lot of force to keep the charge in a mechanically entrapped position in cylinder 48 for two reasons: a) the charge hasn't been ignited so the pressure in the chamber is lower at this particular position, and b) the unique mechanical engagement of the elements maintains low crank arm and rod angle throughout the ECVC cycle, thus requiring less flywheel torque at this angle of engine operation.

Accordingly, as it doesn't rely on flywheel torque to complete the compression stroke, the construction of the crankshaft can be lighter. Unlike the prior art, an epicyclic crankshaft while in operation creates and recovers a new source of orbital momentum. Thus far, such an orbital momentum hasn't been mentioned and studied concerning ICE. In this embodiment, it is expected that orbital momentum will act cooperatively with angular momentum since the vector of the forces has the same direction. Further, the new form of accumulated energy herein combined with the angular momentum will fill in the large power gaps that appear in the conventional model throughout operational cycles and support the concept while compressing a charge.

Turning to FIGS. 32-34 with more detail of the operation of the Zivkovich cycle. The figures are presenting a schematic illustration and partial animation of an orbital-epicyclic crankshaft in V120° engine configuration following an embodiment of the disclosed principles. The ECVC is mechanically set to appear at TDC for four-cycle concepts operation (Settings 1). To achieve even firing intervals of the charge every 120° with firing order R-L-R-L-R-L or 1-2-3-4-5-6 the paired crank throws caries split orbital-epicyclic crankpins offset of 120° sway angle around the center of orbital shaft C1 in the direction of the engine rotation. The valve controlling system and all other elements are omitted for clarity. The figures are meant to focus on the piston's volumetric displacement with the crank position. The scale above the cylinders 44 is from a comparable conventional engine using a square bore-stroke ratio and equal 1.75:1 rod to stroke ratio. At the bottom of the cylinders is shown a scaler of the VR/SR 45 concept's volumetric displacement throughout the operation of an epicyclic crankshaft. Due to being an extra-long but adjustable ECVC cycle and slow motion of the piston at the beginning of the power cycle the ignition of the charge can take place at 5°-15° ATDC point. A mechanical and geometrically locked position of the orbital-epicycle crankpin with center C1 does not require much mechanical force to stay in the ECVC cycle. It could be stated that the VR/SR model saves that unused energy in the form of angular and orbital momentum and creates an overlapped power stroke of 30° with the power stroke of piston 2. The VR/SR model further provides radially overlapped power strokes every 120° of the epicyclic crankshaft motion. The detailed sketch shows the V6 animation labeled as OPS. Observing the animated figures further, it is visually noticeable that all revolving, orbital and reciprocating crank elements are in a constant inherently balanced position. Due to a reversed piston speed of the concept in the second half of its reciprocating motion towards the TDC secondary imbalance is now neutralized, first-order force is balanced (synchronized) by having even firing intervals of 120° and overlapped power strokes of 30°. The crank diameter of both concepts is the same and could be compared at 75° of both crank positions where the irregular VR/SR path intersects with the conventional perfect circular path. This animation has omitted the presence of counterweights for better visual access to other opposed crank arms and opposed orbital shafts.

Another concept as shown in FIG. 35-38 as a result of specifics below mechanically produces a constant volume combustion cycle at TDC in the duration of 30° and a slow increase of the volume (65) when the pistons start to go apart, and as a result of crank throws assembly according to settings 2 inherits as well ECVC cycle at BDC. In order to achieve this constant volume at TDC and BDC is enough to oppose only two cylinders and two pistons.

FIG. 35-38 shows an ultimate quadrangle VR/SR OPOC concept, where ECVC with the orbital shaft is mechanically set to appear at DBC point acting as animated FIGS. 20-26 and its implementation in opposed piston layout two-cycle with exhaust port (EP) and intake port (IP) around BDC (a uniflow scavenging system) and having fuel (FI) injectors in the middle of the cylinder. The following figures are disclosing the way to create ECVC at TDC by rearranging the reciprocating and revolving opposed crank elements in the following way. The crank throws 34a with gear 34b, 33a with gear 33b, 37a with gear 37b, and 38a with gear 38b, the gears having the same diameter and simultaneously revolving in the same direction. A quadrangle layout of crank throws with said gears is meshed with connecting central gear (Cg1) which is revolving in an opposite direction without having strictly set the ratio in between the two groups of gears.

Furthermore in the same concept. Crank throw 34a as is oppose with crank throw 33a and is rotationally in a delayed position for 30° while crank throw 37a is in a rotationally advanced position from crank throw 33a for 90° where its opposed member crank throw 38a as upper opposed throws are rotationally separated for 180°.

Continuing in the same concept. The opposed crank throws 33a and 34a are having equal lengths of the connecting Rods B2 and C2, where pistons B1 and C1 are reciprocating in-cylinder C5 whose total length is altered for the distance which piston linearly passes from 30° to TDC, where the piston B1 follows the piston C1 for the delayed amount of 30° maintaining constant volume combustion cycle (65).

The VR/SR OPOC in FIGS. 35-38 system addresses the problematic horizontal overall length of the prior art OPOC concept. While the illustrated embodiments show a mechanically and internally determined relationship between the orbital rod journal radius and rotation rate of the orbital journal geometry within a single rotation of the crank, it will be appreciated that the presented opposed concept has reduced the horizontal length of the engine due to offset position of the connecting rods towards the center of the rotation (main journal) when the pistons are at BDC and overlapping pistons position's motion around TDC.

Further, in the FIGS. 35-38 with a VR/SR OPOC engine, after the exhaust port closes by the engine A at 240° using the piston's reciprocating motion the engine easily allows up to 45° of the pumping time until the piston B reaches its own 255° to close the inlet ports. The method improves scavenging efficiency without interrupting the angular momentum of all four crankshafts. As a result of a specific offset of the crankshafts and new kinematics of crank elements, the VR/SR OPOC engine uses 0.97% of its total swept volume, which is a much greater volume than the conventional OPOC concept.

Another concept is shown in FIGS. 39-41 is an Opposed Piston-Opposed Cylinder OPOC which is using at least one (1) VR/VSR crank throw per each crankshaft, where each crank throws 41a, 42a, 43a, and 44a according to claim 6 have set ECVC cycle at TDC, having each its own gear 41b, 42b, 43b, and 44b are placed in an engine block to revolve transversally around its own centers in one direction and are meshed with central gear 2 (g2) which is placed in the center of the engine block in ratio 0.5:1, which is revolving around its own center in an opposed direction with the driveshaft in the rear side.

Continuing in FIGS. 39-41. This unique assembly that opposes crank throw 41a with crank throw 42a holding a radial delayed position of 60°, further providing more power strokes per each crank revolution engages crank throw 44a in an advanced position of 180° from crank throw 42a. Crank throw 44a is then opposed to w/crank throw 43a for 180° thus synchronizing the performance of conventional ICE four-cycle operation in an OPOC configuration.

Continuing in FIGS. 39-41. An alternative mechanical concept allows a new mechanical system of controlling intake and exhaust gasses, without using chain or belt, rocker arms shafts, rocker arms, and lifters through a breathing port in the cylinders (a12). A mechanical apparatus which simultaneously spines a gear 3 (g3) as one part of gear 2 (g2) in the exact ratio of 0.5:1 with all four said crank gears, further horizontally engages with gear 4 (g4) and gear 5 (g5) which are caring camshafts (a6 and a7) with eccentrically projected lobs to open and close chambers at a selected timing via spring pre-loaded valves assemblies a8, a9, a10, and a11 with intake manifold a4 and exhaust manifold a5.

When the two opposed pistons simultaneously move in opposite directions the volume in the cylinder is increased at the twice rate seen by a setup of the conventional OTTO crankshafts in OPOC model. Per disclosed principles the ultimate VR/SR OPOC concept provides the increase of the volume at a reduced rate, so from 30°-60° before after TDC point the average value is at 0.68:1, then around 60° is 0.84:1 further at around 90° is registered almost equal to conventional opposed concept and is 1.02:1. The concept creates an extended dual cycle by increasing the MEP and cylinder pressure without motion of the piston, and the slow increase of the volume promises a substantial improvement in torque, power rating and power/weight ratio. A fuller and more complete atomization process at earlier crank angle promises silent engine operation, with clean exhaust cycle and reducing the need for conventionally known techniques and methods to dissolve the unburned gas.

It will be appreciated that a system and method for improved engine operation have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

1. An internal combustion engine (ICE) comprising a crankcase allowing transverse rotation of the crankshaft's main journals inside at least front and rear bearings and at least one piston having a wrist pin, the piston reciprocating within a cylinder, wherein a piston-crank relationship is achieved by linking the piston's wrist pin to an orbital-epicycle crank-pin with a conventional connecting rod.

2. The ICE per claim 1, further comprises an orbital shaft, wherein the orbital-epicycle crank-pin is eccentrically offset from the center of the orbital shaft journals, where the said orbital shaft is one piece with an orbital gear and is configured to transversely spin inside two-piece diametrically split crank arms.

3. The ICE per claim 1 and 2 wherein an orbital gear together with said orbital shaft meshes with a stationary gear in a fixed ratio of 1:1 to rotationally maintain variable crank lever value.

4. The ICE per claim 1, wherein the VR/SR crank mechanism is configured to be reversible and adjustable for a variety of engine applications and different fuel ignition temperature, further creating and following an irregular but vertically symmetrical path with the center of its orbital-epicycle crank pin within each crank revolution.

5. The ICE per claim 4 has an adjustable duration ECVC cycle and slow motion of the piston before and after the BDC.

6. The ICE per claim 4 has an adjustable ECVC cycle and slow motion of the piston before and after the TDC providing a dynamic compression stroke shortened for a ⅙ of its conventional duration, and ATDC given an effect of an increased compression ratio.

7. The ICE in accordance with claim 1 has a coupled crank throw with split orbital-epicycle crank pin arrangement in a horizontal flat plain, four-piston, or V6 120° with two or four-cycle engine operation.

8. A two-cycle OPOC ICE followed claim 1, wherein a quadrangle layout of VR/SR crank mechanisms in OPOC engine is meshed with central gear allows constant volume combustion cycle of 30° to appear at TDC with slower increase of the volume, while ECVC cycle (Extended dwell time) is set to appear at BDC for increase of the scavenging efficiencies through intake and exhaust ports at BDC. Four flywheels do not have to be in a strict ratio with central gear.

9. A two-cycle OPOC ICE per claims 8 and 9 where opposed cr. throw 33a and 34a have equal length of connecting rods B2 and C2 wherein pistons B1 and C1 are reciprocating in a common cylinder C5 of which the total length is altered for the distance which a piston linearly passes from 30° to TDC, thus one piston follows another for the delayed amount of 30° maintaining constant volume combustion cycle 65 at TDC.

10. A four-cycle ICE per claim 1 has at least one VR/RS crank throw per each of four crankshaft in a OPOC configuration with ECVC cycle set to appear at TDC having each its own flywheel gear placed in an engine block to revolve transversally around their own centers in one direction and are meshed with a central gear g2 which is placed in the center of the engine block in a ratio of 0.5:1 which is revolving around its own center in an opposed direction with the drive shaft in the rear side.

11. A four-cycle OPOC ICE in accordance with claim 1, allowing a new mechanical system of controlling intake valve a12 and exhaust valve all throughout a breathing port a12 and intake manifold a4 and exhaust a5 with a mechanical apparatus which simultaneously spines a gear g3 as one part of gear g2 in the exact ratio of 0.5:1 with all four said crank gears, further horizontally engages with gear g4 and gear g5 which are caring exhaust camshafts a6 and intake camshaft a7 with eccentrically projected lobs to open and close chambers at a selected timing via spring pre-loaded valves assemblies a8, a9, a10 and a11.
